(19) United States
(12) Patent Application Publication
(10) Pub. No.: US 2026/0064635 A1
(43) Pub. Date: Mar. 5, 2026

(54) CONTROL METHOD OF STORAGE SYSTEM

(71) Applicant: Samsung Electronics Co., Ltd., Suwon-si (KR)

(72) Inventors: Myoungwon OH, Suwon-si (KR); Sungmin LEE, Suwon-si (KR)

(73) Assignee: Samsung Electronics Co., Ltd., Suwon-si (KR)

(21) Appl. No.: 19/058,306

(22) Filed: Feb. 20, 2025

(30) Foreign Application Priority Data
Sep. 4, 2024 (KR) 10-2024-0120322

(51) Int. Cl. G06F 16/174; G06F 16/13

(52) U.S. Cl. CPC G06F 16/1752; G06F 16/137

(57) ABSTRACT

A control method includes dividing a source data unit among a plurality of source data units received from a host into a plurality of source chunks; generating a unique value for each of the plurality of source chunks; inserting the unique values into a source bloom filter of the source data unit; calculating a Hamming similarity with a storage bloom filter of each of the plurality of active storage data units for the source bloom filter; selecting an active storage data unit based on the highest Hamming similarity as a target data unit; classifying each of the plurality of source chunks as a first deduplicated chunk, an already deduplicated chunk, or a unique chunk using the unique values; and storing at least one of the first deduplicated chunks in the target data unit, such that spatial locality of each chunk may improve and fragmentation may be alleviated.

### CROSS-REFERENCE TO RELATED APPLICATION(S)

This application claims benefit of priority to Korean Patent Application No. 10-2024-0120322 filed on Sep. 4, 2024 in the Korean Intellectual Property Office, the disclosure of which is incorporated herein by reference in its entirety.

### BACKGROUND

Some example embodiments relate to a control method of a storage system.

A storage device may store data in response to a write request and may output the stored data in response to a read request. As a size of data stored in a storage device increases, it may be important to efficiently manage deduplicated data among the data stored in the storage device to efficiently use the limited capacity of the storage device. Deduplication may be a technique of enabling efficient use of capacity of a storage device. Deduplication may include determining whether data to be stored in a storage device deduplicates data already stored in a storage system, and when upon determining the data to be stored deduplicates already stored data, the already stored data may be referenced, instead of storing the data to be stored in the storage. In this case, the data may be divided into chunks of a size, such as of a predetermined size, and deduplication may be performed in chunk units.

### SUMMARY

Some example embodiments may provide a control method of a storage system which may alleviate fragmentation of source chunks by storing at least one firstly deduplicated source chunk among a plurality of source chunks included in a source data unit received from a host in a storage data unit based on relevance.

According to some example embodiments, a control method of a storage system includes dividing a source data unit into a plurality of source chunks, the source data among a plurality of source data units received from a host, the source data a target of deduplication, generating a unique value for each of the plurality of source chunks, inserting the unique values into a source bloom filter of the source data unit and updating the source bloom filter, calculating a Hamming similarity with a storage bloom filter of each of a plurality of active storage data units for the source bloom filter, selecting an active storage data unit based on a highest Hamming similarity among the plurality of active storage data units as a target data unit, classifying each of the plurality of source chunks as one of a first deduplicated chunk, an already deduplicated chunk, or a unique chunk using the unique values, and storing at least one of the first deduplicated chunks in the target data unit.

Alternatively or additionally according to some example embodiments, a control method of a storage system includes dividing a source data unit into a plurality of source chunks, the source unit a target of deduplication, the source unit among a plurality of source data units received from a host, generating a unique value for each of the plurality of source chunks, inserting the unique values into a source bloom filter of the source data unit and updating the source bloom filter, calculating a Hamming similarity with a storage bloom filter of each of a plurality of active storage data units in which a deduplicated chunk is stored for the source bloom filter, selecting a target data unit among the plurality of active storage data units using the Hamming similarities, and adding at least one first deduplicated chunk among the plurality of source chunks to the target data unit.

Alternatively oar additionally according to some example embodiments, a control method of a storage system includes dividing a source data unit, the source data unit being a target of deduplication, into a plurality of source chunks, and generating a unique value of each of the plurality of source chunks, inserting the unique values into a source bloom filter of the source data unit and updating the source bloom filter, calculating a Hamming similarity with a storage bloom filter of each of a plurality of active storage data units in which the deduplicated chunks are stored for the source bloom filter, selecting a target data unit from among the plurality of active storage data units using the Hamming similarities, classifying each of the plurality of source chunks as one of a first deduplicated chunk, an already deduplicated chunk, or a unique chunk using the unique values, adding the first deduplicated chunk to the target data unit and referencing a position of the target data unit to access the first deduplicated chunk, and inserting the first deduplicated chunk into a target bloom filter of the target data unit and updating a bit of the target bloom filter.

### BRIEF DESCRIPTION OF DRAWINGS

The above and other aspects, features, and advantages of some example embodiments will be more clearly understood from the following detailed description, taken in combination with the accompanying drawings, in which:

FIG. 1 is a block diagram illustrating a storage system according to some example embodiments;

FIG. 2 is a block diagram illustrating a controller of a storage device according to some example embodiments;

FIG. 3 is a block diagram illustrating a memory device according to some example embodiments;

FIG. 4 is a diagram illustrating a 3D V-NAND structure applicable to a storage device according to some example embodiments;

FIG. 5 is a diagram illustrating a hierarchical structure of a storage system according to some example embodiments;

FIG. 6 is a diagram illustrating a source data group, a duplication data group, and a referencing group according to some example embodiments;

FIG. 7 is a block diagram illustrating a deduplication engine according to some example embodiments;

FIG. 8 is a flowchart illustrating a deduplication process of a source data unit according to some example embodiments;

FIG. 9 is a flowchart illustrating a process for selecting a target data unit by detecting similarity according to some example embodiments;

FIG. 10 is a flowchart illustrating a process for performing deduplication by distinguishing a source chunk according to some example embodiments;

FIG. 11 is a diagram illustrating a source data unit and a source bloom filter according to some example embodiments;

FIG. 12 and FIG. 13 are diagrams illustrating a deduplication process according to some example embodiments;

FIGS. 14 and 15 are diagrams illustrating a deduplication process according to some example embodiments;

FIGS. 16 and 17 are diagrams illustrating a deduplication process according to some example embodiments;

FIGS. 18 and 19 are diagrams illustrating a deduplication process according to some example embodiments;

FIGS. 20 and 21 are diagrams illustrating a deduplication process according to some example embodiments;

FIG. 22 is a diagram illustrating an effect of deduplication according to some example embodiments;

FIG. 23 is a diagram illustrating an effect of deduplication according to some example embodiments; and

FIG. 24 is a diagram illustrating a system to which a storage device is applied according to some example embodiments.

### DETAILED DESCRIPTION

In the description below, example embodiments of the present disclosure will be described as follows with reference to the accompanying drawings.

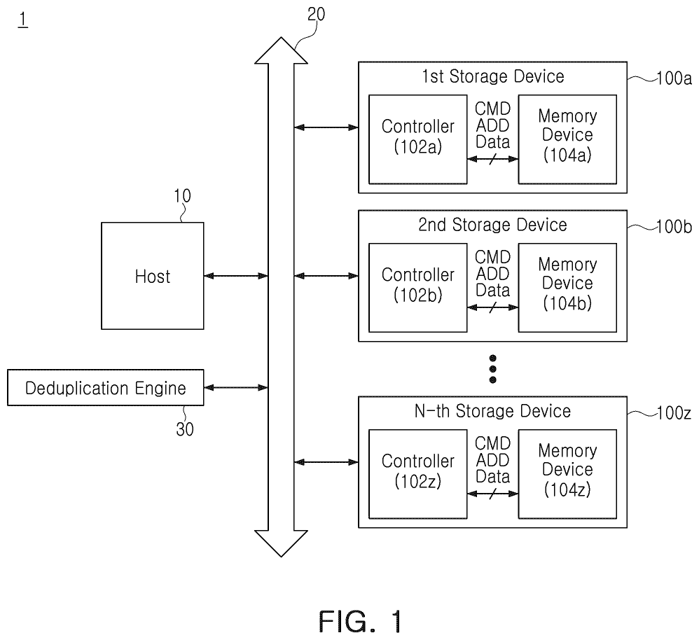

FIG. 1 is a block diagram illustrating a storage system according to some example embodiments.

FIG. 1 illustrates a storage system 1. The storage system 1 may be configured as a computing system configured to process various information, such as one or more of a data center, a server, a personal computer, a notebook, a laptop, a server, a workstation, a tablet PC (personal computer), a smartphone, a digital camera, a black box, or the like. The host 10 may include at least one operating system (OS). The operating system may manage and control some or all, e.g., the overall functions and/or operations of the host 10.

The storage system 1 may include the host 10, a bus 20, a deduplication engine 30, and a plurality of storage devices 100a-100z. The plurality of storage devices 100a-100z may also be referred to as first to Nth storage devices 100a-100z. N may be an arbitrary natural number.

The host 10 may control some or all, e.g., the overall operations of the storage system 1. For example, the host 10 may communicate with the plurality of storage devices 100a-100z through the bus 20. The host 10 may store data to the plurality of storage devices 100a-100z, or may read data stored in the plurality of storage devices 100a-100z.

The bus 20 may provide an interface for communication between the host 10, the deduplication engine 30, and the plurality of storage devices 100a-100z. For example, the bus 20 may be configured as a peripheral component interconnect express (PCIe) bus. The bus 20 may be implemented as a wired bus and/or a wireless bus; example embodiments are not limited thereto. The host 10 may read data stored in the plurality of storage devices 100a-100z, and/or may write data in the plurality of storage devices 100a-100z through the bus 20. The plurality of storage devices 100a-100z may communicate with each other in a peer-to-peer (P2P) manner through the bus 20.

Each of the plurality of storage devices 100a-100z may include storage media for storing data in response to a request from the host 10. For example, each of the plurality of storage devices 100a-100z may include at least one of a solid state drive (SSD), an embedded memory, and a removable external memory. Each of the plurality of storage devices 100a-100xz may include the same type, and/or different types, of storage media, having the same, or different, capacity and/or the same, or different, read and/or write times. When the plurality of storage devices 100a-100z are configured as SSDs, the plurality of storage devices 100a-100z may be devices which comply with the non-volatile memory express (NVMe) standard. Alternatively or additionally, when the plurality of storage devices 100a-100z are embedded memory or external memory, the plurality of storage devices 100a-100z may be devices which comply with the universal flash storage (UFS) and/or embedded multi-media card (eMMC) standard. Each of the host 10 and the plurality of storage devices 100a-100z may generate a packet according to the adopted standard protocol and may transmit the packet.

Each of the plurality of storage devices 100a-100z may store data received from the host 10 or may provide the stored data to the host 10. Each of the plurality of storage devices 100a-100z may communicate with each other, e.g., in a one-way, two-way, or multiway communication method such as a broadcast mechanism, to share and exchange data such as but not limited to data and/or instructions, in a serial and/or parallel manner, encoded in an analog and/or digital format; example embodiments are not limited thereto.

Each of the plurality of storage devices 100a-100z may include a controller 102a-102z (102) and memory devices 104a-104z (104). Functions and structures of the plurality of storage devices 100a-100z may be similar to each other; example embodiments are not limited thereto.

The memory device 104 may maintain stored data even when power is not supplied. The memory device 104 may store data provided from the host 10 through a program operation that may involve setting a voltage of a memory cell, and may output data stored in the memory device 104 through a write and/or read operation. The memory device 104 may include a plurality of memory blocks, each of the memory blocks may include a plurality of pages, and each of the pages may include a plurality of memory cells connected to a wordline.

When memory devices 104a-104z of each of the plurality of storage devices 100a-100z include flash memory; the flash memory may include a 2D NAND memory array and/or a 3D (or vertical) NAND (VNAND) memory array. Alternatively or additionally, each of the plurality of storage devices 100a-100z may include various types of nonvolatile memories. For example, each of the plurality of storage devices 100a-100z may include one or more of a magnetic RAM (MRAM), spin-transfer torque MRAM (spin-transfer torque MRAM), conductive bridging RAM (CBRAM), ferroelectric RAM (FeRAM), phase RAM (PRAM), resistive RAM, and various types of other memories, and each of the plurality of storage devices 100a-100z may include the same or different memory types.

The controller 102 may control the memory device 104 in response to a request from the host 10. For example, the controller 102 may provide data read from the memory device 104 to the host 10 and may program data provided from the host 10 to the memory device 104.

The deduplication engine 30 may manage duplication data stored in the plurality of memory devices 104a-104z. Depending on various factors such as one or more of characteristics of the application and file, characteristics of a user, and availability of backup data, duplication data having the same content as the data provided from the host 10 may be stored in at least one of the plurality of memory devices 104a-104z. Duplicating and storing data having the same content multiple times may cause unnecessary waste of capacity of the storage system 1.

The deduplication engine 30 may perform deduplication of a plurality of pieces of the same data. Deduplication may be or may include, or be included in an operation of storing only one data and managing the other to reference to the stored data instead of storing the entirety of the plurality of pieces of the same data. For example, when deduplication of duplication data is performed, duplication data stored in the memory device may be deleted, and/or duplication data temporarily stored in a volatile memory such as a write buffer memory may be discarded. By performing deduplication, capacity of the storage system 1 may be ensured or may help to be ensured by the size of duplication data, such that the storage system 1 having improved efficiency of capacity may be provided.

The deduplication engine 30 may communicate with the plurality of storage devices 100a-100z in a P2P manner. For example, the deduplication engine 30 may communicate in a P2P manner through various standards such as one or more of a controller memory buffer (CMP) and persistent memory region (PMR) of non-volatile memory express (NVMe), compute express link (CXL), or cache coherent interconnect for accelerators (CCIX).

The deduplication engine 30 in some example embodiments may divide data into a plurality of chunks and may perform deduplication on each of the plurality of chunks. In some example embodiments, the deduplication engine 30 may divide a data unit received from the host 10 into a plurality of chunks and may generate a unique value for each of the plurality of chunks. For example, the data unit may have an object structure in which data and metadata about the data are combined. However, example embodiments thereof are not limited thereto.

When at least one of the plurality of storage devices 100a-100z already include a data unit received from the host 10 and a unique value to be deduplicated, and/or when a unique value to be deduplicated is included in the received data unit, deduplication may be performed on at least one chunk corresponding to the deduplicated unique value. For example, the deduplication engine 30 may store only a single chunk among the plurality of chunks having the unique value to be deduplicated, and the other chunks may be accessed by referencing the stored chunk.

In a general storage system, as deduplication is repeatedly performed on data units, chunks may be stored at non-consecutive memory addresses. Since deduplication is repeatedly performed on chunks initially stored at consecutive memory addresses, chunks may be physically distributed and stored. Accordingly, each of the data chunks may lose spatial locality, and fragmentation of the data chunks may occur.

However, the deduplication engine 30 in some example embodiments may perform deduplication on at least one first deduplicated chunk of a data unit which may be a deduplication target, and may determine a position at which the deduplicated chunk is stored so as to prevent fragmentation of the data unit. Chunks to be deduplicated in a data unit received from a host may be stored in storage data units. The storage data unit may refer to a data unit storing a deduplicated chunk.

When the deduplicated chunk and the same chunk are already stored in a storage data unit, only the position information may be updated to reference the position of the stored chunk. When the deduplicated chunk is not stored in the storage data units as the first deduplicated chunk, the chunk may be stored in one of the storage data units, and the position information may be updated.

In some example embodiments, the deduplication engine 30 may determine the storage data unit in which the first deduplicated chunk may be stored based on a relevance between the data unit which may be the deduplication target and the plurality of storage data units. For example, among the plurality of storage data units, the first deduplicated chunk may be stored in the storage data unit including the largest number of data chunks, which may be the same as the data chunks of the data unit which may be the deduplication target. For example, a possibility that data chunks related to each other are included in the same storage data unit may increase.

At least one first deduplicated chunk may be stored in consecutive memory addresses of the storage data unit. Accordingly, spatial locality of each of the chunk may be improved, thereby alleviating or improving upon fragmentation. Thus, when the data unit which may be the deduplication target is output, the number of times the chunk is read may be reduced.

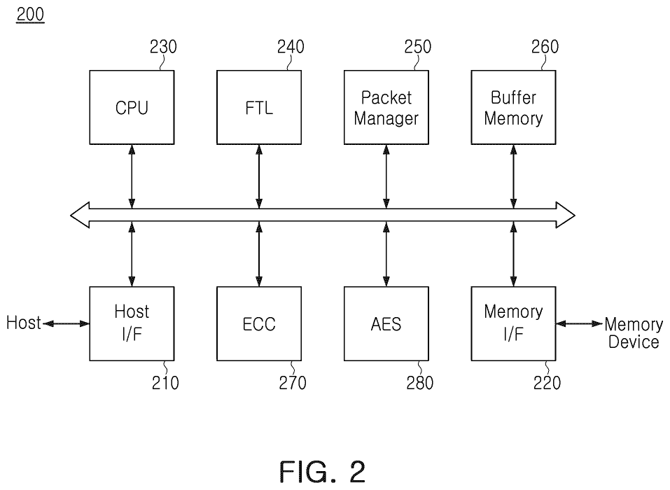

FIG. 2 is a block diagram illustrating a controller of a storage device according to some example embodiments.

FIG. 2 may correspond to a block diagram embodying controllers 102a-102z; 102 of the storage device in FIG. 1 in some example embodiments. A controller 200 may control memory device in response to a request from a host. For example, the controller 200 may provide data read from a memory device to a host and may program data provided from the host to the memory device. In this case, the host may correspond to the host 10 in FIG. 1, and the memory device may correspond to one of the plurality of memory devices 104a-104z in FIG. 1.

The controller 200 may include a host interface 210, a memory interface 220, and a central processing unit (CPU) 230. Also, the controller 200 may further include a flash translation layer (FTL), 240, a packet manager 250, a buffer memory 260, an error correction code (ECC) engine 270, and an advanced encryption standard (AES) engine 280. The controller 200 may further include a working memory (not illustrated) into which the flash translation layer 240 is loaded, and data program and read operations for the memory device may be controlled by the CPU 230 executing the flash translation layer 240.

The host interface 210 may transmit a packet to and/or receive a packet from the host. A packet transmitted from the host to the host interface 210 may include a command and/or data to be programmed in the memory device, and a packet transmitted from the host interface 210 to the host may include a command and/or data to be programmed in the memory device. A packet may include a response to a command and/or data read from a memory device.

The memory interface 220 may transmit data to be programmed into the memory device to the memory device or receive data read from the memory device. The memory interface 220 may be implemented to comply with a standard protocol such as Toggle and/or open NAND flash interface (ONFI).

The CPU 230 may control some, e.g., the overall operation of the controller 200.

The flash translation layer 240 may perform various functions such as one or more of address mapping, wear-leveling, and garbage collection. An address mapping operation may be of changing a logical address received from a host into a physical address used to actually store data in the memory device. Wear-leveling may be a technique for preventing or reducing excessive deterioration of a specific block by allowing blocks in the memory device to be used evenly, and may be implemented through a firmware technology for balancing erase counts of physical blocks, for example. Garbage collection may be a technique for ensuring or helping to ensure available capacity in the memory device 220 by copying valid data of a block to a new block and erasing an existing block.

The packet manager 250 may generate a packet according to the protocol of an interface agreed upon with the host, or may parse various information from a packet received from the host. Also, the buffer memory 260 may temporarily store data to be programmed into the memory device or data to be read from the memory device. The buffer memory 260 may be configured to be provided in the controller 200, or may be disposed externally of the controller 200.

The ECC engine 270 may perform error detection and correction functions for read data read from the memory device. In some example embodiments, the ECC engine 270 may generate parity bits for write data to be written to the memory device, and the generated parity bits may be stored in the memory device together with the write data. When data is read from the memory device, the ECC engine 270 may correct errors in the read data using the parity bits read from the memory device together with the read data, and may output the error-corrected read data.

The AES engine 280 may perform at least one of an encryption operation and a decryption operation for data input to the controller 200, e.g. by using a symmetric key algorithm.

When data having the same content is stored in the memory device among the data provided from the host, deduplication may be performed on the duplication data. In this case, deduplication may correspond to inline deduplication, post-process deduplication, or delta compression.

For example, in inline deduplication in which deduplication is performed in real time before data is stored in a memory device, pieces of data provided from a host may be stored first in the buffer memory 260 before deduplication is completed. After deduplication is completed, non-duplicated data may be stored in the memory device.

For another example, in post-process deduplication, data provided from a host may be stored in a memory device, and thereafter, deduplication may be performed on the duplication data. Deduplication may be performed in the order in which data is provided from the host. Duplication data may be deleted from the memory device, and the position of the previously stored data may be referenced to access the duplication data.

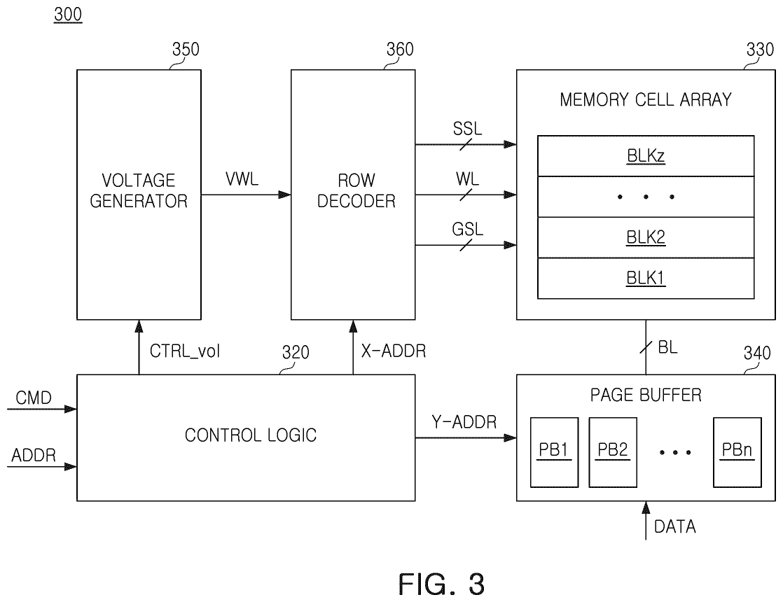

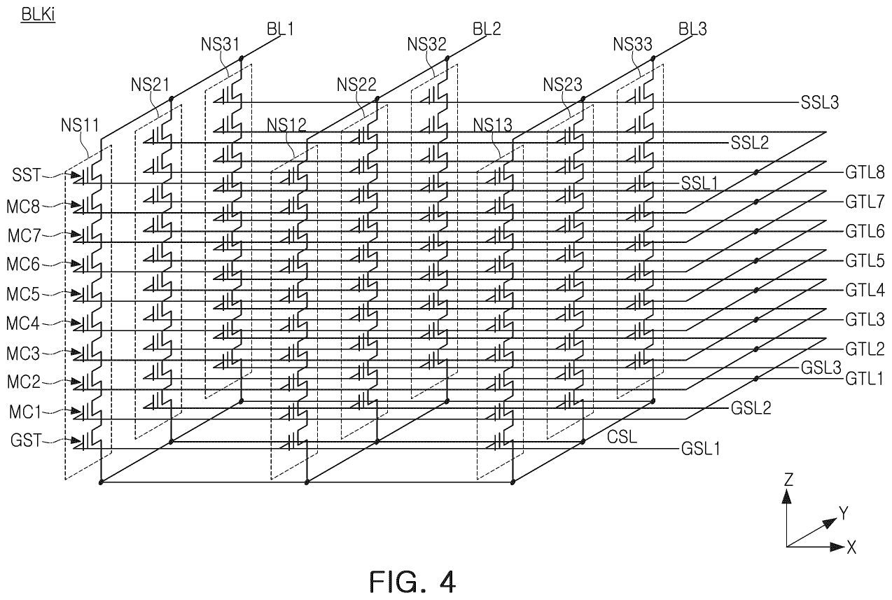

FIG. 3 is a block diagram illustrating a memory device according to some example embodiments. FIG. 4 is a diagram illustrating a 3D V-NAND structure applicable to a storage device according to some example embodiments.

Referring to FIG. 3, the memory device 300 may include a control logic circuit 320, a memory cell array 330, a page buffer 340, a voltage generator 350, and a row decoder 360. The memory device 300 may further include a memory interface circuit for receiving a command CMD and an address ADDR from an external entity and exchanging data DATA with an external entity, and may further include a column logic, a pre-decoder, a temperature sensor, a command decoder, an address decoder, or the like.

The control logic circuit 320 may generally control various operations in the memory device 300. The control logic circuit 320 may output various control signals in response to a command CMD and/or an address ADDR from the memory interface circuit 310. For example, the control logic circuit 320 may output a voltage control signal CTRL_vol, a row address X-ADDR, and a column address Y-ADDR.

The memory cell array 330 may include a plurality of memory blocks BLK1-BLKz (where z is a positive integer), and each of the plurality of memory blocks BLK1-BLKz may include a plurality of memory cells. The memory cell array 330 may be connected to a page buffer 340 through bitlines BL, and may be connected to a row decoder 360 through wordlines WL, string select lines SSL, and ground select lines GSL.

As an example, the memory cell array 330 may include a three-dimensional memory cell array, and the three-dimensional memory cell array may include a plurality of NAND strings. Each NAND string may include memory cells connected to wordlines vertically stacked on a substrate, respectively. In some example embodiments, the memory cell array 330 may include a two-dimensional memory cell array, and the two-dimensional memory cell array may include a plurality of NAND strings disposed along row and column directions. The memory cell array 330 may include one or more of a single-level cell (SLC), or a multi-level cell (MLC), or a triple-level cell (TLC), or a quad-level cell (QLC); example embodiments are not limited thereto.

The page buffer 340 may include a plurality of page buffers PB1 to PBn (where n is an integer equal to or greater than 3), and the plurality of page buffers PB1 to PBn may be connected to memory cells through a plurality of bitlines BL, respectively. Here, n may be greater than, less than, or equal to z. The page buffer 340 may select at least one bitline from among the bitlines BL in response to the column address Y-ADDR. The page buffer 340 may operate as a write driver or a sense amplifier depending on an operation mode. For example, in a program operation, the page buffer 340 may apply a bitline voltage corresponding to data to be programmed to the selected bitline. In a read operation, the page buffer 340 may sense data stored in the memory cell by sensing a current or voltage of the selected bitline.

The voltage generator 350 may generate various types of voltages for performing program, read, and erase operations based on a voltage control signal CTRL_vol. For example, the voltage generator 350 may generate a program voltage, read voltage, program verification voltage, erase voltage, or the like as a wordline voltage VWL.

The row decoder 360 may select one of a plurality of wordlines WL and one of a plurality of string select lines SSL in response to the row address X-ADDR. For example, during a program operation, the row decoder 360 may apply the program voltage and may program verification voltage to the selected wordline, and during a read operation, the row decoder 360 may apply the read voltage to the selected wordline.

FIG. 4 illustrates a 3D V-NAND structure which may be applied to a some example embodiments. When the memory device (300 in FIG. 3) of the storage device is implemented as or includes a 3D V-NAND type flash memory, each of the plurality of memory blocks included in the memory device may be represented as an equivalent circuit as illustrated in FIG. 4. For example, the plurality of memory NAND strings included in the memory block BLKi may be formed in a direction perpendicular to the substrate.

Referring to FIG. 4, the memory block BLKi may include a plurality of memory NAND strings NS11-NS33 connected between bitlines BL1, BL2, and BL3 and a common source line CSL. Each of the plurality of memory NAND strings NS11-NS33 may include a string select transistor SST, a plurality of memory cells MC1, MC2, . . . , MC8 and a ground select transistor GST. In FIG. 3, the plurality of memory NAND strings NS11-NS33 may include eight memory cells MC1, MC2, . . . , MC8, but example embodiments thereof are not limited thereto.

A string select transistor SST may be connected to corresponding string select lines SSL1, SSL2, and SSL3. The plurality of memory cells MC1, MC2, . . . , MC8 may be connected to corresponding gate lines GTL1, GTL2, . . . , GTL8, respectively. The gate lines GTL1, GTL2, . . . , GTL8 may correspond to wordlines, and a portion of the gate lines GTL1, GTL2, . . . , GTL8 may correspond to a dummy wordline. A ground select transistor GST may be connected to corresponding ground select lines GSL1, GSL2, and GSL3. The string select transistor SST may be connected to corresponding bitlines BL1, BL2, and BL3, and the ground select transistor GST may be connected to a common source line CSL.

Wordlines (e.g., WL1) at the same level may be commonly connected, and ground select lines GSL1, GSL2, and GSL3 and string select lines SSL1, SSL2, and SSL3 may be isolated from each other, respectively. In FIG. 3, the memory block BLK may be connected to eight gate lines GTL1, GTL2, . . . , GTL8 and three bitlines BL1, BL2, and BL3 example embodiments thereof are not limited thereto.

some example embodiments, a source data unit, which is a target of deduplication among a plurality of pieces of data units received from the host 10 in FIG. 1, may be divided into a plurality of chunks and may be deduplicated. At least one first deduplicated chunk among the plurality of chunks may be stored in one of the plurality of storage data units. The storage data unit may store already deduplicated chunks. For example, when two or more of the same chunks are determined to be duplicated, the chunks may be stored in the storage data unit.

The storage data unit according to some example embodiments may be configured as a store space to which consecutive memory addresses of memory cells arranged in physically adjacent regions on the memory cell array 330 are directed. In other words, at least one first deduplicated chunk of the source data unit may be stored in the consecutive memory addresses of the storage data unit.

Referring to FIG. 3 together, the storage data unit may correspond to a plurality of memory blocks BLK1-BLKz, or a portion of adjacent memory blocks among the plurality of memory blocks BLK1-BLKz. Alternatively, the storage data unit may correspond to one of the plurality of memory blocks BLK1-BLKz. Referring to FIG. 4 together, the storage data unit may correspond to a portion of adjacent memory NAND strings among the plurality of memory NAND strings NS11-NS33. However, the configuration of the storage data unit may not be limited thereto.

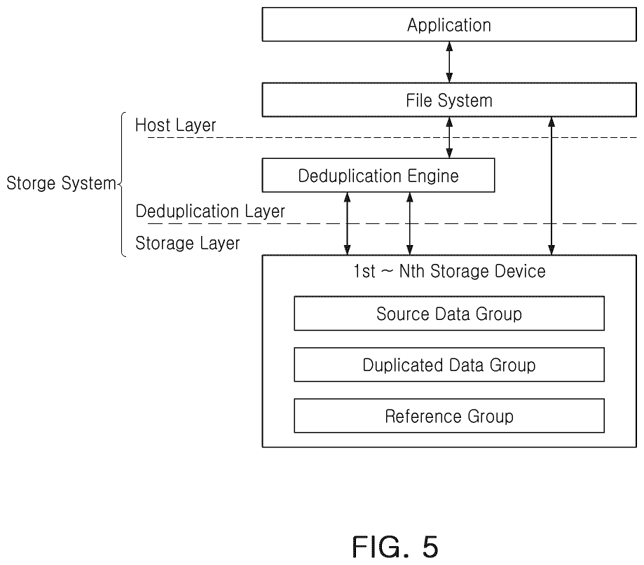

FIG. 5 is a diagram illustrating a hierarchical structure of a storage some example embodiments.

Referring to FIG. 5, a storage system according to some example embodiments may have a software hierarchical structure including a host layer, a deduplication layer, and a storage layer.

The host layer may include an application and a file system. An application may be or may include a software program designed to perform a specific function. For example, an application may include one or more of a word processor, a database program, a web browser, an image editing program, or the like. The application may communicate with a user of the storage system through a user interface device such as a touch screen, a monitor, a mouse, a keyboard, a microphone, a speaker, or the like.

A file system may manage files. The file system may systematically manage operations such as one or more of generating a file, accessing a file, opening a file, modifying a file, and deleting a file in response to an operation of an operating system or a request from an application executed by the operating system. A file may be a series of data. A series of data corresponding to a file may be stored in the storage layer.

The file system may include one or more of FAT, FAT32, NTFS, HFS (hierarchical file system), JSF2 (journaled file system2, XFS, ODS-5 (on-disk structure-5), UDF, ZFS, UFS (UNIX file system), ext2, ext3, ext4, ReiserFS, Reiser4, ISO, 9660, Gnome, VFS, EFS, or WinFS.

The deduplication layer may include a deduplication engine, and the deduplication engine may manage performance of deduplication for a plurality of pieces of data stored in the storage layer under control of the file system. The deduplication engine may manage performance of inline deduplication or post-process deduplication. In inline deduplication, the deduplication engine may perform deduplication before data is stored in the storage device, and non-duplicated data may be stored in the storage device. In post-process deduplication, the file system may store non-duplicated data in a storage device, and the deduplication engine may search for data stored in the storage device and may perform deduplication. However, the type of deduplication may not be limited thereto.

The storage layer may include the first to Nth storage devices. The first to Nth storage devices may include a source data group, a duplication data group, and a referencing group. Each of the first to Nth storage devices may be included in one of the groups. Alternatively, the first to Nth storage devices may be included in the entirety of the groups.

The deduplication engine may communicate with the storage layer and may deduplicate and manage the same plurality of chunks. A chunk may be a unit obtained by dividing data into a predetermined size. When the same plurality of chunks are determined to be duplicated, the chunk may be stored in the duplication data group. The chunks included in the source data group may be managed to reference the stored chunk in the duplication data group in order to access the stored chunks in the duplication data group. Reference information for each chunk may be stored in the reference group.

In some example embodiments, the duplication data group may include a plurality of storage data units. The storage data unit may store chunks at consecutive memory addresses.

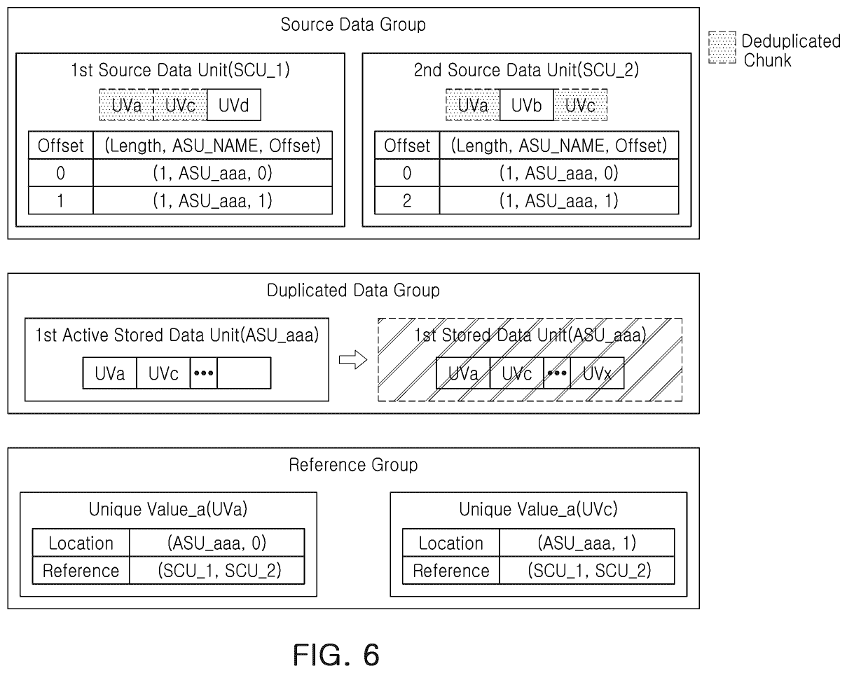

Hereinafter, the source data group, the duplication data group, and the referencing group included in the storage layer may be described in detail with reference to FIG. 6.

FIG. 6 is a diagram illustrating a source data group, a duplication data group, and a referencing group according to some example embodiments.

The storage system in some example embodiments may deduplicate a plurality of pieces of the same data, and the deduplication may enable capacity of the storage system to be used efficiently. Specific example embodiments of the storage system may be similar to the examples described with reference to FIGS. 1 to 5.

The data provided from the host (10 in FIG. 1) may be or may be referred to as a data unit, and the data unit may be an object structure in which data and metadata about the data are combined. Deduplication may be performed on chunks obtained by dividing, e.g., by partitioning, the data unit into a size such as a predetermined size. For example, the data unit may be a megabyte (MB) unit, and the chunk may be a kilobyte (KB) unit. However, the data unit and/or the chunk may not be limited thereto a unit.

A plurality of storage devices may include a source data group and a duplication data group. One of the same plurality of chunks may be stored in the duplication data group, and the source data group may reference the stored chunk. In some example embodiments, a non-deduplicated chunk may be stored in the source data group. In this case, the source data group may store chunks by a source data unit SCU provided from the host, or may refer to a stored chunk in the duplication data group. The duplication data group may include an active storage data unit ASU and/or a storage data chunks may be stored by unit.

The active storage data unit ASU may be or may correspond to a data unit in which new chunks may be further stored, and the storage data unit may be or may correspond to a data unit in which new chunks may not be further stored. Specifically, an allowable size may be determined for the active storage data unit ASU, and the allowable size may be a storage capacity such as a predetermined storage capacity. The active storage data unit ASU and the storage data unit may be distinguished based on the allowable size.

The size of the active storage data unit ASU may be smaller than the allowable size. When chunks are stored in the active storage data unit ASU and the size of the active storage data unit ASU is equal to or greater than the allowable size, the active storage data unit ASU may be changed to a storage data unit such that new chunks may be controlled to not be further stored.

In some example embodiments, deduplication may be performed using a unique value of a chunk. The unique value of a chunk may have a fixed size and in some cases may be generated by a hash function. For example, the unique value of a chunk may have a fixed size of 20 bytes by secure hash algorithm-1 (SHA-1). The secure hash algorithm-1 (SHA-1) may be a fingerprint of or a hash of the chunk; in some example embodiments, the hash may or may not be salted with other information such as but not limited to a time of day. However, the type of hash function and/or the size of the unique value may not be limited thereto.

The storage system in some example embodiments may divide a source data unit SCU into a plurality of source chunks and may generate a unique value for each of the plurality of source chunks. The storage system may determine whether a chunk should be deduplicated using the unique values of the source data unit.

Deduplication may be performed in the order in which the source data units are provided from the host. In some example embodiments illustrated in FIG. 6, the first source data unit SCU_1 and the second source data unit SCU_2 may be provided in order.

The first source data unit SCU_1 may include a number of chunks, such as first to third source chunks, and may be divided or partitioned into a size such as a predetermined size. The unique values of each of the first to third source chunks may be a unique value a UVa, a unique value c UVc, and a unique value d UVd in order. The second source data unit SCU_2 may include first to third source chunks, and may be divided or partitioned into a size such as a predetermined size. The unique values of each of the first to third source chunks may be the unique value a UVa, the unique value b UVb, and the unique value c UVc in order.

Before the first source data unit SCU_1 is provided from the host, a previously provided source data unit SCU may not be present. Since no chunk having the same unique value is present among the three source chunks of the first source data unit SCU_1, the three source chunks of the first source data unit SCU_1 may not be deduplicated. In such a case, the three source chunks of the first source data unit SCU_1 may be stored in the source data group, and no stored chunk may be present in the duplication data group.

Thereafter, the second source data unit SCU_2 may be provided from the host. The second source data unit SCU_2 may include the same unique value as the first source data unit SCU_1. For example, the unique values of the first and third source chunks of the second source data unit SCU_2 may be the same as the unique values of the first and second source chunks of the first source data unit SCU_1, respectively. The first chunk of the first source data unit SCU_1 and the first chunk of the second source data unit SCU_2 corresponding to the unique value a UVa may be deduplicated. The second chunk of the first source data unit SCU_1 and the third chunk of the second source data unit SCU_2 corresponding to the unique value c UVc may be deduplicated. For example, the chunks may be classified as a first deduplicated chunk.

The third chunk of the first source data unit SCU_1 corresponding to the unique value d UVd and the second chunk of the second source data unit SCU_2 corresponding to the unique value b UVb may be classified as non-deduplicated unique chunks.

The storage system may generate the first active storage data unit to store the chunks to be deduplicated. The active storage data unit may include a unique name. The name of the first active storage data unit may be ‘ASU_aaa.’

In the first chunk of the first source data unit SCU_1 and the first chunk of the second source data unit SCU_2 corresponding to the unique value a UVa, the chunk corresponding to the unique value a UVa may be stored in the first active storage data unit ASU_aaa. In order to access the first chunk of the first source data unit SCU_1 or the first chunk of the second source data unit SCU_2, the chunk stored in the first active storage data unit ASU_aaa may be referenced. In this case, information such as a position of the first active storage data unit ASU_aaa in which the chunk corresponding to the unique value a UVa is stored may be referenced, and the reference information may be stored in the first and second source data units SCU_1 and SCU_2.

In the second chunk of the first source data unit SCU_1 and the third chunk of the second source data unit SCU_2 corresponding to the unique value c UVc, the chunk corresponding to the unique value c UVc may be stored in the first active storage data unit ASU_aaa. In order to access the second chunk of the first source data unit SCU_1 or the third chunk of the second source data unit SCU_2, the chunk stored in the first active storage data unit ASU_aaa may be referenced. In this case, information such as the position of the first active storage data unit ASU_aaa in which the chunk corresponding to unique value c UVc is stored may be referenced, and the reference information may be stored in the first and second source data units SCU_1 and SCU_2.

As illustrated in some example embodiments described with reference to FIG. 6, reference information may be formed and stored in a table format, but example embodiments thereof are not limited thereto. The reference information may include a length of a chunk referenced by an offset of a source data unit, a name of an active storage data unit in which the referenced chunk is stored, and an offset of an active storage data unit in which the referenced chunk is stored. The offset may indicate a relative distance at which a chunk is positioned in the data unit, and in some cases may begin at ‘0’.

As an example, in a deduplicated first chunk of the first source data unit SCU_1, the offset of the first chunk may be ‘0.’ The length (the run length) of the referenced chunk may be ‘1,’ the name of the active storage data unit in which the referenced chunk is stored may be ‘ASU_aaa,’ and the offset of the active storage data unit in which the referenced chunk is stored may be ‘0.’

As another example, in the deduplicated third chunk of the second source data unit SCU_2, the offset of the third chunk may be ‘2.’ The length of the referenced chunk may be ‘1,’ the name of the active storage data unit in which the referenced chunk is stored may be ‘ASU_aaa,’ and the offset of the active storage data unit in which the referenced chunk is stored may be ‘1.’

The non-deduplicated chunk may be stored in the source data group. Specifically, the third chunk of the first source data unit SCU_1 corresponding to the unique value d UVd may be stored in the first source data unit SCU_1. The second chunk of the second source data unit SCU_2 corresponding to the unique value b UVb may be stored in the second source data unit SCU_2.

The plurality of storage devices in some example embodiments may further include a referencing group. The referencing group may include information about the storage position and the referencing source data unit for each deduplicated chunk. As some example embodiments illustrated in FIG. 6, the pieces of information may be formed and stored in a table format for each deduplicated chunk, but example embodiments thereof are not limited thereto.

For example, a deduplicated chunk corresponding to the unique value a UVa may be stored in the first active storage data unit ASU_aaa, and the offset may be ‘0.’ The source data units referencing the deduplicated chunk corresponding to the unique value a UVb may be the first and second source data units SCU_1 and SCU_2. For another example, a deduplicated chunk corresponding to the unique value c UVc may be stored in the first active storage data unit ASU_aaa, and the offset may be ‘1.’ The source data units referencing the deduplicated chunk corresponding to the unique value c UVc may be the first and second source data units SCU_1 and SCU_2.

Thereafter, the plurality of source data units may be provided from the host, and deduplication may be repeatedly performed on the plurality of source data units. The number of source data units included in the source data group may increase, and the number of active storage data units included in the duplication data group may increase. The number of deduplicated chunks stored in the active storage data units may increase.

For example, as deduplicated chunks are further stored in the first active data unit ASU_aaa, the size of the first active data unit ASU_aaa may become equal to or greater than the allowable size. In this case, the first active data unit ASU_aaa may be changed to the first data unit ASU_aaa, such that no new chunks may be further stored in the first data unit ASU_aaa.

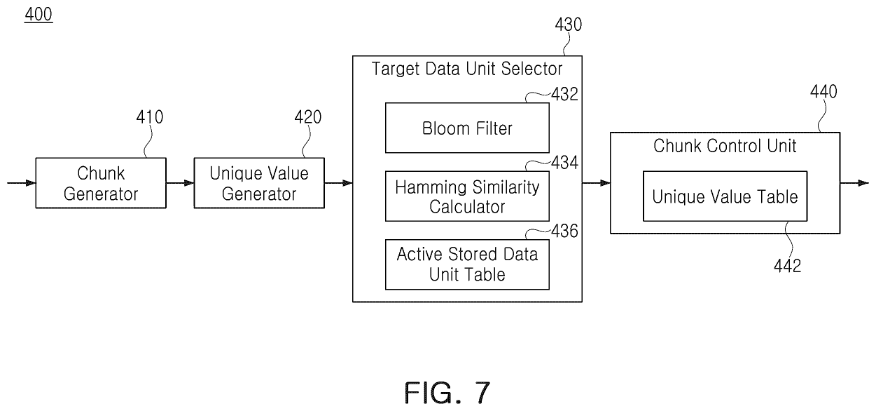

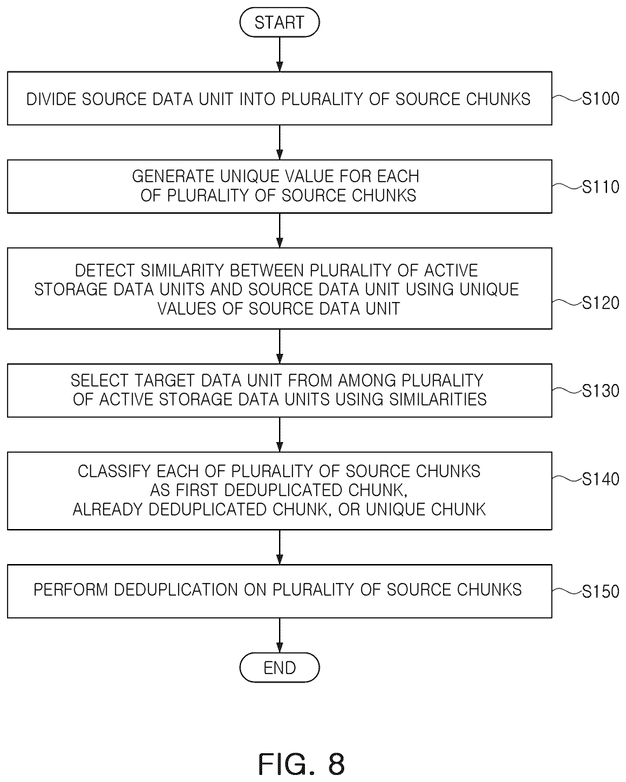

The storage system in some example embodiments may select an active storage data unit in which a deduplicated chunk may be stored using relevance. In this case, a similarity with the plurality of active storage data units for a source data unit may be calculated, which will be described in greater detail below with reference to FIGS. 7 and 8.

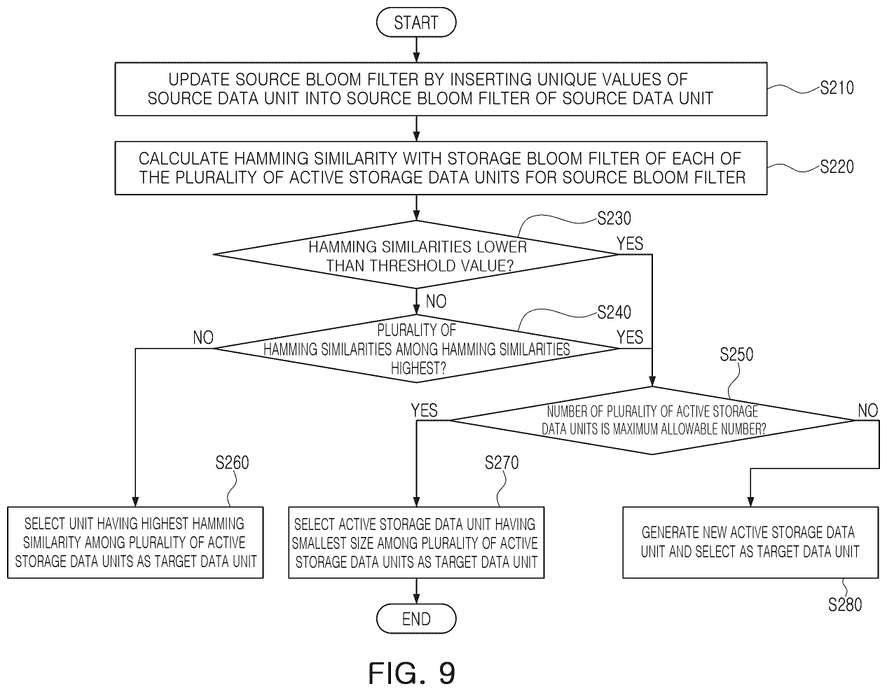

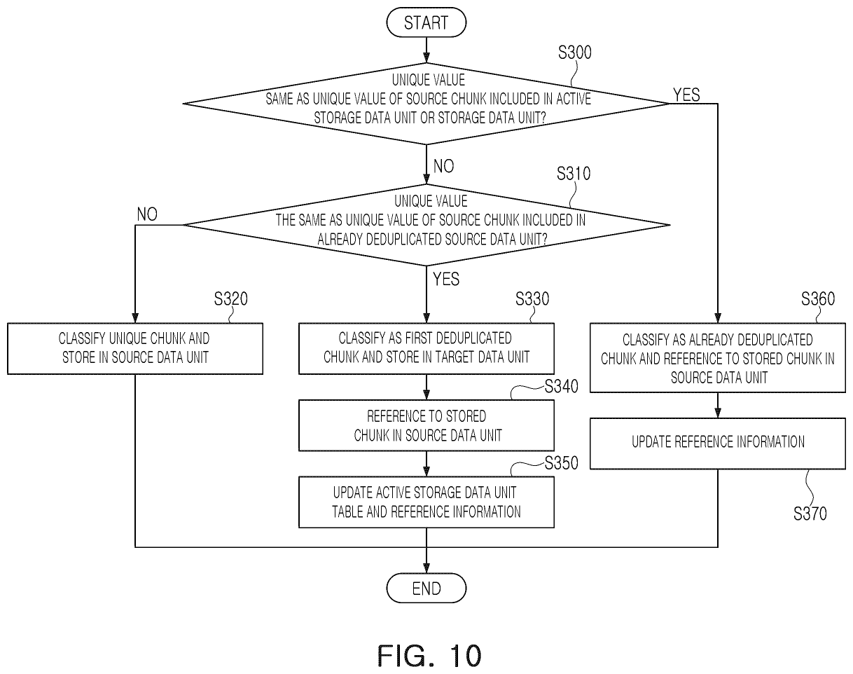

FIG. 7 is a block diagram illustrating a deduplication engine according to some example embodiments. FIG. 8 is a flowchart illustrating a deduplication process of a source data unit according to some example embodiments. FIG. 9 is a flowchart illustrating a process for selecting a target data unit by detecting similarity according to some example embodiments. FIG. 10 is a flowchart illustrating a process for performing deduplication by distinguishing a source chunk according to some example embodiments.

The storage system may include a host, a plurality of storage devices, and a deduplication engine. When data provided from the host to the plurality of storage devices is programmed, the deduplication engine may more efficiently manage capacity of the storage system by deduplication of duplicated data. The data provided from the host may be a source data unit. Specific non-limiting example embodiments of the storage system may be similar to the examples described with reference to FIGS. 1 to 6.

Referring to FIG. 7, a deduplication engine 400 according to some example embodiments may include a chunk generator 410, a unique value generator 420, a target data unit selector 430, and a chunk controller 440. The target data unit selector 430 may include a bloom filter 432, a Hamming similarity calculator 434, and an active duplication data unit table 436. The chunk controller 440 may include a unique value table 442.

For example, the unique value table 442 may include unique values for source data units for which deduplication has already been performed, a plurality of active storage data units, and chunks referencing stored chunks and stored chunks in at least one storage data unit. The unique value table 442 may have a form similar to that of the referencing group in some example embodiments illustrated in FIG. 6, but some example embodiments thereof is not limited thereto.

Components of the target data unit selector 430 may communicate with one another to send and/or receive information such as but not limited to data and/or commands, which may be transmitted over a bus such as but not limited to a wired bus and/or a wireless bus. The information may be sent and/or received in a broadcast manner, or a one-way manner, or a two-way manner, and may be sent and/or received in a serial and/or parallel manner, and may be encoded in a digital and/or analog fashion. Example embodiments are not limited thereto.

Referring to FIG. 7 and FIG. 8 together, the chunk generator 410 may receive a source data unit and may divide (e.g., partition) the source data unit into a plurality of source chunks (S100). The source chunk may be or may correspond to a data unit obtained by dividing the source data unit into a size such as but not limited to a predetermined size. The unique value generator 420 may generate a unique value for each of the plurality of source chunks (S110). The unique value of the chunk may have a fixed size generated by a hash function.

The target data unit selector 430 may detect a similarity between a plurality of active storage data units and the source data unit using the unique values of the source data unit (S120). The target data unit selector 430 may select a target data unit from among a plurality of active storage data units using the calculated similarities (S130). The processes S120 and S130 may be described in greater detail with reference to FIG. 9.

Referring also to FIG. 9, the target data unit selector 430 may update the source bloom filter by inserting the unique values of the source data unit into the source bloom filter 432 of the source data unit (S210).

The target data unit selector 430 may detect a similarity using the source bloom filter and storage bloom filters. In this case, the storage bloom filters may be loaded from the active storage data unit table 436. The active storage data unit table 436 may include information about the name of the active storage data unit, the storage bloom filter, and the present size.

In some example embodiments, the source bloom filter and the storage bloom filter may be or include (or be included in) data structures in which the result values of the unique values of the source data unit or storage data unit input to a hash function are indexed into an array of bits. For example, the source bloom filter may probabilistically indicate whether a source chunk having a specific unique value is included in the corresponding source data unit, and the storage bloom filter may probabilistically indicate whether a chunk having a specific unique value is included in the corresponding storage data unit.

As a non-limiting example, the similarity may be Hamming similarity, e.g., a one's count similarity. The Hamming similarity calculator 434 may calculate the Hamming similarity with the storage bloom filter of each of the plurality of active storage data units for the source bloom filter (S220). The storage bloom filter of each of the plurality of active storage data units may be stored in the active storage data unit table 436.

The target data unit selector 430 may select the target data unit using calculated Hamming similarities in the S220 process (S230 to S280). When the Hamming similarities are greater than a threshold value and the plurality of Hamming similarities among the Hamming similarities are not the highest (NO of S230 and NO of S240), the target data unit selector 430 may select the unit having the highest Hamming similarity among the plurality of active storage data units as the target data unit (S260). In this case, the threshold value may be configured as a predetermined positive number.

When the Hamming similarities are lower than the threshold value (YES of S230) or the plurality of Hamming similarities among the Hamming similarities are the highest (YES of S240), the target data unit selector 430 may select the target data unit according to the number of the plurality of active storage data units (S250).

When the number of the plurality of active storage data units is the maximum allowable number (YES in S250), the target data unit selector 430 may select the active storage data unit having the smallest size among the plurality of active storage data units as the target data unit (S270).

When the number of the plurality of active storage data units is equal to or less than the maximum allowable number (NO in S250), the target data unit selector 430 may generate a new active storage data unit and select the unit as the target data unit (S280).

Referring to FIGS. 7 and 8, the chunk controller 440 may classify each of the plurality of source chunks as a first deduplicated chunk, an already deduplicated chunk, or a unique chunk using unique values (S140). In this case, the chunk controller 440 may use the unique values of the stored chunk in the unique value table 442. Thereafter, the chunk controller 440 may perform deduplication on the plurality of source chunks (S150). The processes S140 and S150 may be described in greater detail with reference to FIG. 10.

When the unique value the same as the unique value of the source chunk are not included in the active storage data unit or the storage data unit and a unique value the same as the unique value of the source chunk are not included in the already deduplicated source data unit (NO in S300 and NO in S310), the chunk controller 440 may classify the source chunk as a unique chunk and store the chunk in the source data unit (S320).

Among the plurality of source chunks, a non-deduplicated chunk may be classified as a unique chunk. In other words, among the plurality of source chunks, the chunks other than the first deduplicated chunk and the already deduplicated chunk may be classified as unique chunks.

When the unique value that is the same as the unique value of the source chunk is not included in the active storage data unit or the storage data unit (NO of S300) but the unique value that is the same as the unique value of the source chunk is included in the already deduplicated source data unit (YES of S310), the chunk controller 440 may classify the source chunk as the first deduplicated chunk and may store the chunk in the target data unit (S330). The chunk controller 440 may manage that the stored chunk may be referenced to the target data unit in the source data unit (S340).

The chunk controller 440 may update the active storage data unit table and reference information (S350). Some specific non-limiting example embodiments of the reference information may be similar to the example described with reference to FIG. 6.

When the unique value the same as the unique value of the source chunk is included in the active storage data unit or the storage data unit (YES in S300), the chunk controller 440 may classify the source chunk as an already deduplicated chunk and may manage that the stored chunk may be referenced to the active storage data unit or the storage data unit in the source data unit (S360). The chunk controller 440 may update the reference information (S370).

According to some example embodiments, a target data unit may be selected based on similarity, and at least one first deduplicated chunk may be stored in the target data unit. In other words, at least one first deduplicated chunk may be stored in consecutive memory addresses. Accordingly, fragmentation of chunks may be alleviated, such that the number of times chunks are read to output a data unit, which may be a deduplication target, may be reduced.

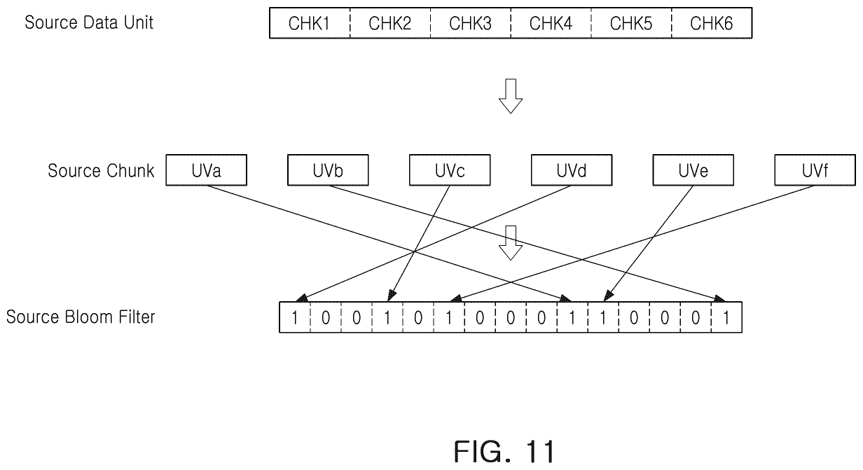

FIG. 11 is a diagram illustrating a source data unit and a source bloom filter according to some example embodiments.

According to some example embodiments, a source data unit may be divided (e.g., partitioned) into a plurality of source chunks that may or may not have the same size as each other, and a unique value of each of the plurality of source chunks may be generated. The unique values may be inserted into a bloom filter, such that the source bloom filter of the source data unit may be updated. In this case, at least one hash function may be used. The source bloom filter may be configured as an array of bits. The source bloom filter may have a predetermined size corresponding to the number of bits.

In some example embodiments illustrated in FIG. 11, a source data unit may be divided or partitioned into first to sixth source chunks CHK1-CHK6. For each of the first to sixth source chunks CHK1-CHK6, unique values a to f UVa-UVf may be generated. For example, the unique value of the first source chunk CHK1 may correspond to the unique value a UVa, and the unique value of the sixth source chunk CHK6 may correspond to the unique value f UVf.

According to some example embodiments illustrated in FIG. 11, the source bloom filter may use 15 bits. The unique values a to f UVa-UVf may be inserted into the source bloom filter of the source data unit, such that the source bloom filter may be updated. The values of the bits corresponding to the unique values a to f UVa-UVf may be configured from the initial state (0) to the configured state (1). The 1st, 4th, 6th, 10th, 11th, and 15th bits of the source bloom filter may be configured from the initial state (0) to the configured state (1).

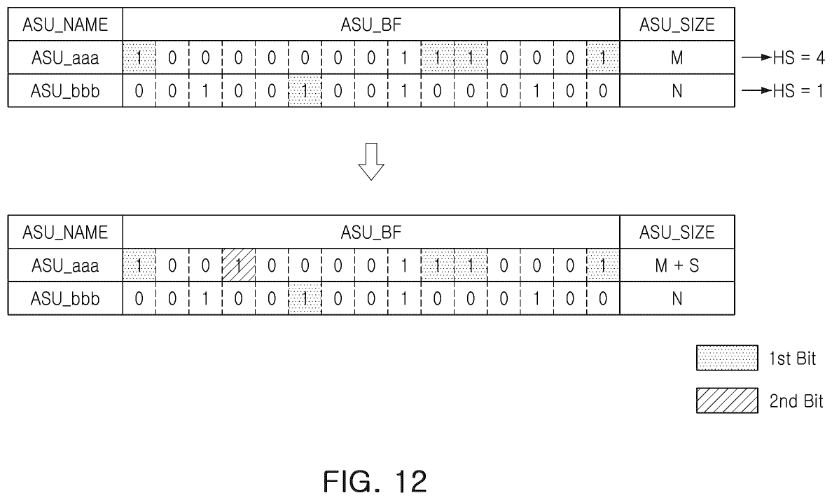

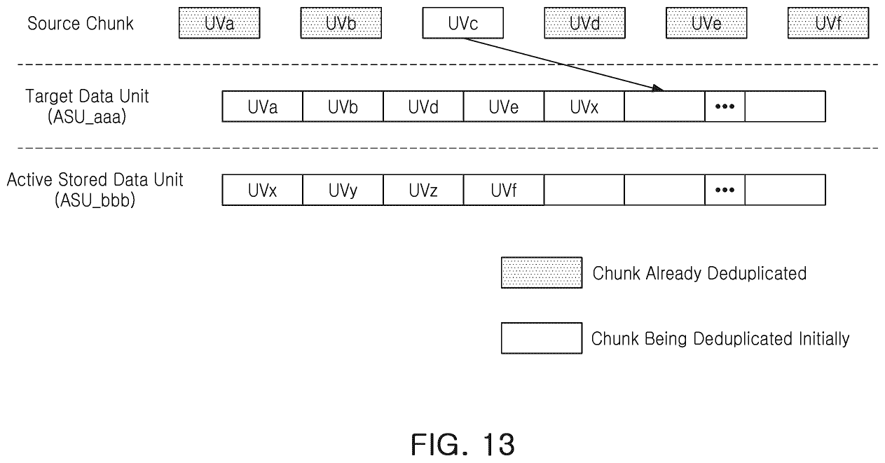

FIG. 12 and FIG. 13 are diagrams illustrating a deduplication process according to some example embodiments.

The storage device may calculate a Hamming similarity between a plurality of active storage data units and each storage bloom filter for a source bloom filter. The target data unit may be selected from among a plurality of active storage data units using the calculated Hamming similarities. In this case, the storage bloom filters may be loaded from the active storage data unit table. The processes may correspond to processes S220 to S280 in FIG. 9 described above.

An active storage data unit table in some example embodiments may be described with reference to FIG. 12. The active storage data unit table in some example embodiments illustrated in FIG. 12 may include information about a name ASU_NAME of the active storage data unit, a storage bloom filter ASU_BF, and a present size ASU_SIZE. The active storage data unit table may be updated whenever deduplication is performed.

The active storage data unit table may further include the generation time of the active storage data unit, the address of the storage device in which the active storage data unit is included, the identifier ID of the storage device in which the active storage data unit is included, the last time at which the chunk is stored in the active storage data unit, and/or the identifier ID of the deduplication engine.

In some example embodiments illustrated in FIG. 12, the name ASU_NAME of the active storage data unit may first include the unique value of the stored chunk. The name of the first active storage data unit may correspond to ‘ASU_aaa,’ and the name of the second active storage data unit may correspond to ‘ASU_bbb.’ However, some example embodiments thereof are not limited thereto.

The unique value of at least one chunk stored in the active storage data unit may be inserted into the storage bloom filter ASU_BF of the active storage data unit, such that the storage bloom filter ASU_BF may be updated. In this case, at least one hash function may be used. The storage bloom filter may be configured in an array of bits. The bloom filter may have a predetermined size corresponding to the number of bits. The storage bloom filter ASU_BF in some example embodiments illustrated in FIG. 12 may use 15 bits.

Referring to FIG. 11 together, the size of the source bloom filter and the size of the storage bloom filter may be the same. Also, the size of the source bloom filter and the size of the storage bloom filter may be larger than the number of chunks allowed for each of a plurality of active storage data units. For example, the source bloom filter and the storage bloom filter may include 15 bits. In this case, the number of chunks allowed for the active storage data unit may be less than 15. In other words, 14 or less chunks may be stored in the active storage data unit.

The present size ASU_SIZE of the source bloom filter may represent the current stored capacity of the source bloom filter. The size of the source bloom filter may increase as a chunk is stored. That is, as deduplication is performed repeatedly, the size of the source bloom filter may be changed.

FIG. 12 may represent an active storage data unit table before and after deduplication is performed for a source data unit. Referring to the active storage data unit table before deduplication is performed, the duplication data group may include the first and second active storage data units ASU_aaa and ASU_bbb. The allowable sizes of the first and second active storage data units ASU_aaa and ASU_bbb may be the same.

In order to select a target data unit among the first and second active storage data units ASU_aaa and ASU_bbb, the Hamming similarity for each of the first and second active storage data units ASU_aaa and ASU_bbb may be calculated. Specifically, for the source bloom filter in some example embodiments illustrated in FIG. 11, a Hamming similarity with the storage bloom filter of each of the first and second active storage data units ASU_aaa and ASU_bbb may be calculated.

A Hamming similarity may represent the number of positions in which each of values of the bits of the same position is ‘1’ in the source bloom filter and the storage bloom filter. The bloom filter may roughly represent whether chunks having a specific unique value are included in the corresponding data unit. The higher the Hamming similarity, the greater the number of chunks having the same unique value in the source data unit and the active storage data unit may be. In FIG. 12, the bit having the value of ‘1’ in both the source bloom filter and the storage bloom filter may be illustrated as the 1st bit.

A Hamming similarity may be described by referring to the active storage data unit table before deduplication in some example embodiments illustrated in FIG. 12 is performed. For the source bloom filter in some example embodiments illustrated in FIG. 11, the number of positions in which a value of each of bits of the same position in the storage bloom filter of the first active storage data unit ASU_aaa is ‘1’ may be 4. For the source bloom filter in some example embodiments illustrated in FIG. 11, the Hamming similarity with the bloom filter of the first active storage data unit ASU_aaa may be ‘4.’

For the source bloom filter in some example embodiments illustrated in FIG. 11, the number of positions in which a value of each of the bits of the same position in the storage bloom filter of the second active storage data unit ASU_bbb is ‘1’ may be 1. For the source bloom filter in some example embodiments illustrated in FIG. 11, the Hamming similarity with the bloom filter of the second active storage data unit ASU_bbb may be ‘1.’

In some example embodiments, when the Hamming similarities are higher than the threshold value and the plurality of Hamming similarities among the Hamming similarities re not the highest, a unit such as the unit having the highest Hamming similarity from among the plurality of active storage data units may be selected as a target data unit.

The threshold value may be configured as a number such as a predetermined positive number. The threshold value may be varied depending on the number of the plurality of active storage data units. Alternatively or additionally, the threshold value may be varied depending on the distribution of the Hamming similarities. For example, when the number of the plurality of active storage data units is less than the predetermined number, the unit may be sensitive to even a small Hamming similarity and a new active storage data unit may not be generated. In this case, the threshold value may be adjusted upward.

In another example, when the distribution of Hamming similarities is lower than a specific or predetermined level, active chunks may be stored intensively in a specific active store data region having a high Hamming similarity. In this case, the threshold value may be adjusted downward so as to be sensitive to a Hamming similarity.

In some example embodiments in FIG. 12 and FIG. 13, the threshold value may be determined to be ‘1.’ In this case, the calculated Hamming similarities 1 and 4 may be higher than the threshold value 1. Also, since only one Hamming similarity among the calculated Hamming similarities 1 and 4 is the highest, the plurality of Hamming similarities are not be the highest. Accordingly, the first active storage data unit ASU_aaa having the highest Hamming similarity 4 may be selected as the target data unit. The example embodiment in FIG. 12 and FIG. 13 may correspond to the example described with reference to operation S260 in FIG. 9.

Referring to FIG. 13, a process of storing a first deduplicated source chunk among a plurality of source chunks in a target data unit may be described. The source data unit of some example embodiments illustrated in FIG. 11 may be divided into first to sixth source chunks CHK1-CHK6 having unique values a to f UVa-UVf.

Source chunks CHK1, CHK2, CHK4, and CHK5 corresponding to a unique value a, unique value b, unique value d, and unique value e UVa, UVb, UVd, and UVe, which may be equally included in the source data unit and the first or second active storage data unit ASU_aaa and AUS_bbb, may be classified as already deduplicated chunks. The source data unit may be managed such that each of the source chunks CHK1, CHK2, CHK4, and CHK5 reference to a position stored in the first or second active storage data unit ASU_aaa and AUS_bbb.

The source chunk CHK3 corresponding to the unique value c UVc equally included in the source data unit and the already deduplicated source data unit (not illustrated) may be classified as the first deduplicated chunk. The source chunk CHK3 may be stored in the target data unit ASU_aaa, and the source data unit may be managed such that the source chunk may reference to the position stored in the target data unit ASU_aaa.

Referring to the active storage data unit table after the deduplication in some example embodiments illustrated in FIG. 12 is performed, the unique value c UVc may be inserted into the source bloom filter of the first active storage data unit ASU_aaa, such that the source bloom filter may be updated. For example, the fourth bit of the source bloom filter of the first active storage data unit ASU_aaa may be configured from the initial state (0) to the configured state (1). Also, the present size of the first active storage data unit ASU_aaa may increase by S. In this case, S may be capacity of source chunk CHK3 stored in the first active storage data unit ASU_aaa.

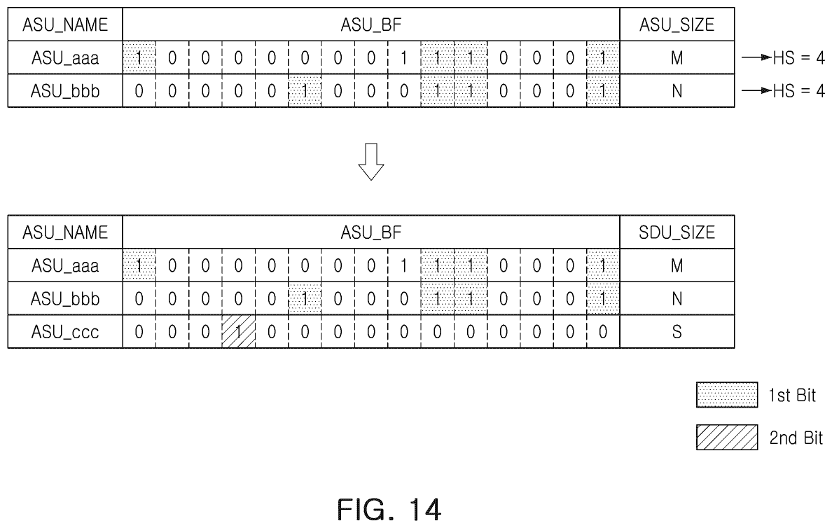

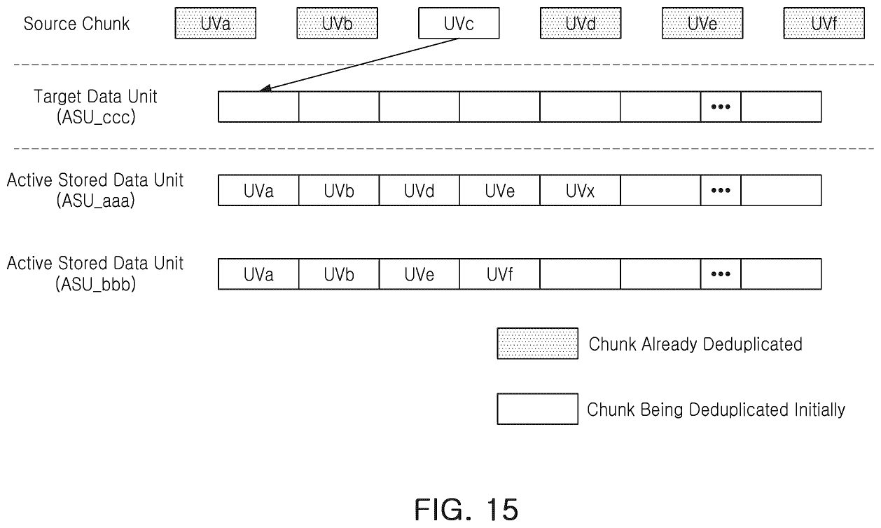

FIGS. 14 and 15 are diagrams illustrating a deduplication process according to example embodiments.

The active storage data unit table illustrated in FIG. 14 and the process of storing the source chunk into the target data unit as illustrated in FIG. 15 may be similar to the examples described with reference to FIG. 12 and FIG. 13 above. In the description below, the differences from FIG. 12 and FIG. 13 may be described.

Referring to FIG. 14, each of Hamming similarities of the bloom filters of the first and second active storage data units ASU_aaa and ASU_bbb for the source bloom filter in some example embodiments illustrated in FIG. 11 may be the same as ‘4.’

The calculated Hamming similarities 4 may be higher than a threshold value 1. However, the plurality of calculated Hamming similarities 4 may be the highest. In some example embodiments in FIG. 12 and FIG. 13, the number of the plurality of active storage data units, which is 2, may be equal to or less than the maximum allowable number N. As described with reference to operation S280 in FIG. 9, a new third active storage data unit ASU_ccc may be generated, and the third active storage data unit ASU_ccc may be selected as a target data unit.

Source chunks CHK1, CHK2, CHK4, and CHK5 corresponding to unique value a, unique value b, unique value d, and unique value e UVa, UVb, UVd, and UVe, which are equally included in the source data unit and the first or second active storage data unit ASU_aaa and AUS_bbb, may be classified as already deduplicated chunks. The source data unit may be managed such that each of the source chunks CHK1, CHK2, CHK4, and CHK5 may reference to a position stored in the first or second active storage data unit ASU_aaa and AUS_bbb.

The source chunk CHK3 corresponding to the unique value c UVc equally included in the source data unit and the already deduplicated source data unit (not illustrated) may be classified as the first deduplicated chunk. The source chunk CHK3 may be stored in the target data unit ASU_ccc, and the source data unit may be managed such that the source chunk may reference to the position stored in the target data unit ASU_ccc.

Referring to the active storage data unit table after the deduplication in some example embodiments illustrated in FIG. 14 is performed, the unique value c UVc may be inserted into the source bloom filter of the third active storage data unit ASU_ccc, such that the source bloom filter may be updated. In this case, the fourth bit of the source bloom filter of the third active storage data unit ASU_ccc may be configured from the initial state (0) to the configured state (1). Also, the present size of the third active storage data unit ASU_ccc may increase by S. In this case, S may be capacity of the source chunk CHK3 stored in the third active storage data unit ASU_ccc.

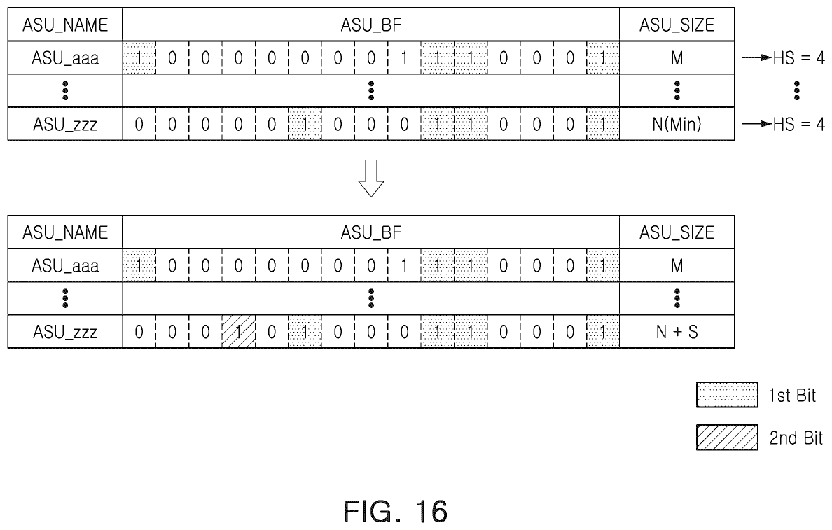

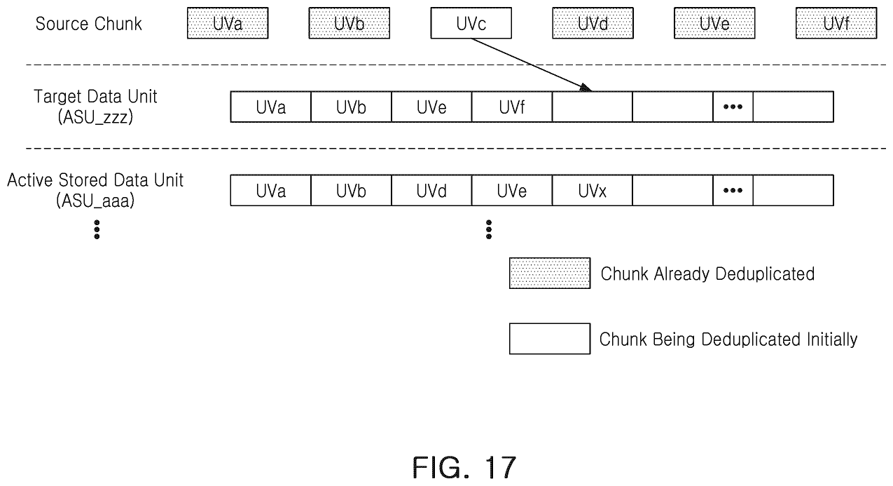

FIGS. 16 and 17 are diagrams illustrating a deduplication process according to example embodiments.

The process of storing the active storage data unit table illustrated in FIG. 16 and the source chunk illustrated in FIG. 17 into the target data unit may be similar to the examples described with reference to FIG. 14 and FIG. 15 above. In the description below, the differences from FIG. 14 and FIG. 15 will be described.

Referring to FIG. 16, the duplication data group may include the first to Nth active storage data unit. For the source bloom filter in some example embodiments illustrated in FIG. 11, the Hamming similarities of a bloom filter of each of the first to Nth active storage data unit ASU_aaa-ASU_zzz may be the same as ‘4.’

The calculated Hamming similarities, 4, may be higher than a threshold value 1. However, the plurality of calculated Hamming similarities, 4, may be the highest. As some example embodiments in FIG. 16 and FIG. 17, the number of the plurality of active storage data units, N, may be the maximum allowable number N. As described with reference to operation S280 in FIG. 9, the Nth active storage data unit ASU_zzz having the smallest size among the first to Nth active storage data units ASU_aaa-ASU_zzz may be selected as a target data unit.

Source chunks CHK1, CHK2, CHK4, and CHK5 corresponding to unique value a, unique value b, unique value d, and unique value e UVa, UVb, UVd, and UVe which may be equally included in at least one of the source data unit and the first to Nth active storage data units ASU_aaa-AUS_zzz may be classified as already deduplicated chunks. The source data unit may be managed such that each of the source chunks CHK1, CHK2, CHK4, and CHK5 may reference to a position stored in the first to Nth active storage data unit ASU_aaa-AUS_zzz.

The source chunk CHK3 corresponding to the unique value c UVc which may be equally included in the source data unit and the already deduplicated source data unit (not illustrated) may be classified as the first deduplicated chunk. The source chunk CHK3 may be stored in the target data unit ASU_zzz, and the source data unit may be managed such that the source chunk may reference to a position stored in the target data unit ASU_zzz.

Referring to the active storage data unit table after the deduplication in some example embodiments illustrated in FIG. 16 is performed, the unique value c UVc may be inserted into the source bloom filter of the Nth data unit ASU_zzz, such that the source bloom filter may be updated. In this case, the fourth bit of the source bloom filter of the Nth data unit ASU_zzz may be configured from the initial state (0) to the configured state (1). Also, the present size of the Nth data unit ASU_zzz may increase by S. In this case, S may be capacity of the source chunk CHK3 stored in the Nth data unit ASU_zzz.

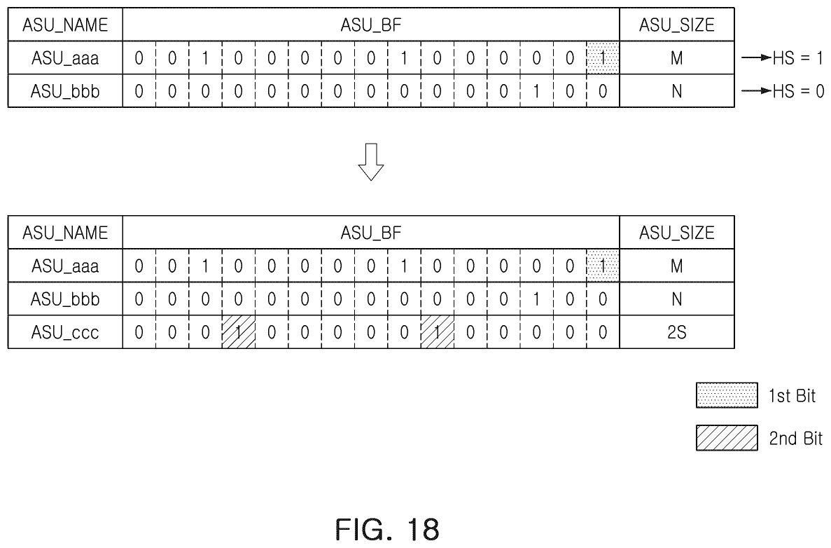

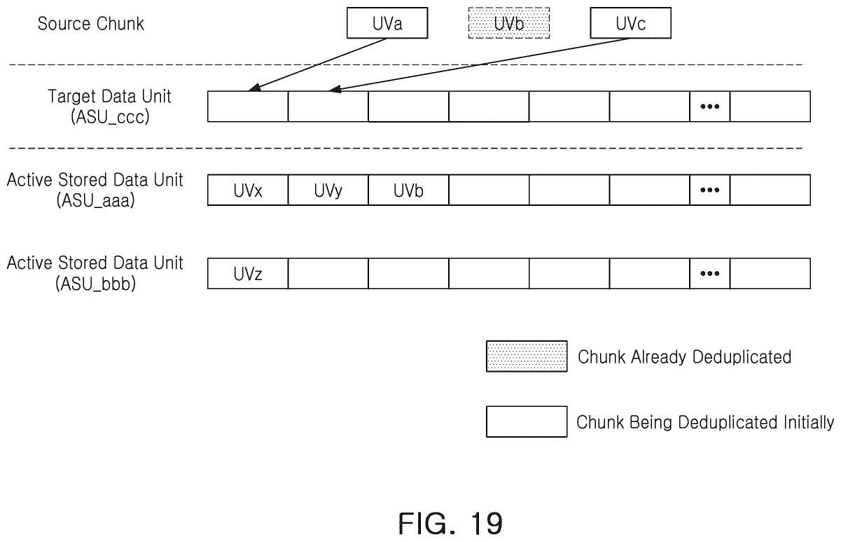

FIGS. 18 and 19 are diagrams illustrating a deduplication process according to example embodiments.

The process of storing the active storage data unit table illustrated in FIG. 18 and the source chunk illustrated in FIG. 19 in the target data unit may be similar to the examples described with reference to FIG. 12 and FIG. 13 above. Hereinafter, the differences from FIG. 12 and FIG. 13 will be described.

Referring to FIG. 18, for the source bloom filter in the example embodiment illustrated in FIG. 11, the Hamming similarity with the bloom filter of the first active storage data unit ASU_aaa may be ‘1.’ For the source bloom filter in the example embodiment illustrated in FIG. 11, the Hamming similarity with the bloom filter of the second active storage data unit ASU_bbb may be ‘0.’

As some example embodiments in FIG. 18 and FIG. 19, the threshold value may be configured as ‘3.’ The calculated Hamming similarities 1 and 0 may not be higher than the threshold value 3. As some example embodiments in FIG. 18 and FIG. 19, the number of a plurality of active storage data units, 2, may equal to or less than the maximum allowable number N. As described with reference to operation S280 in FIG. 9, a new third active storage data unit ASU_ccc may be generated, and the third active storage data unit ASU_ccc may be selected as a target data unit.

The source chunk CHK2 corresponding to the unique value b UVb equally included in the source data unit and the first or second active storage data unit ASU_aaa and AUS_bbb may be classified as an already deduplicated chunk. The source data unit may be managed such that the source chunk CHK2 may reference to the position stored in the first active storage data unit ASU_aaa.

The source chunks CHK1 and CHK3 corresponding to the unique value a and the unique value c UVa and UVc, equally included in the source data unit and the already deduplicated source data unit (not illustrated), may be classified as the first deduplicated chunk. The source chunks CHK1 and CHK3 may be stored in the target data unit ASU_ccc, and the source data unit may be managed such that the source chunks may reference to the positions stored in the target data unit ASU_ccc.

Referring to the active storage data unit table after the deduplication in some example embodiments illustrated in FIG. 18 is performed, the unique value a and the unique value c UVa and UVc may be inserted into the source bloom filter of the third active storage data unit ASU_ccc, such that the source bloom filter may be updated. In this case, the fourth and first0 bits of the source bloom filter of the third active storage data unit ASU_ccc may be configured from the initial state (0) to the configured state (1). Also, the present size of the third active storage data unit ASU_ccc may be increased by 2S. In this case, 2S may be the sum of capacities of the source chunks CHK1 and CHK3 stored in the third active storage data unit ASU_ccc.

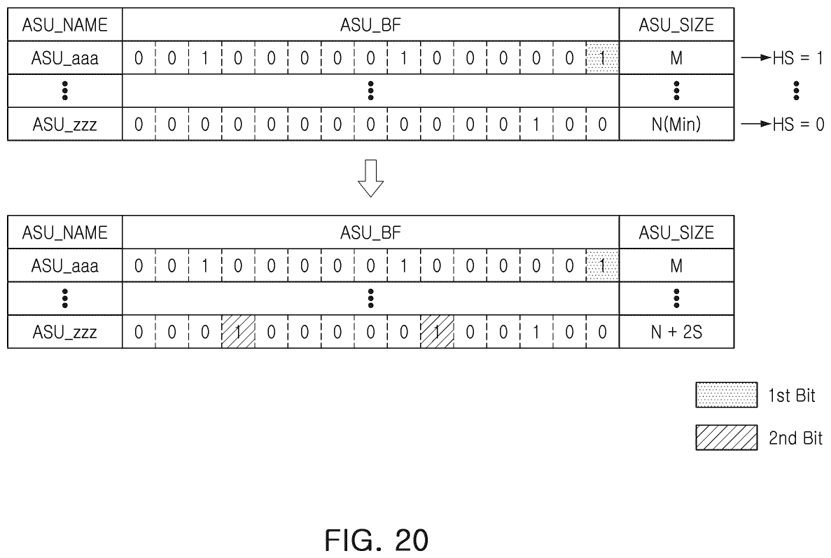

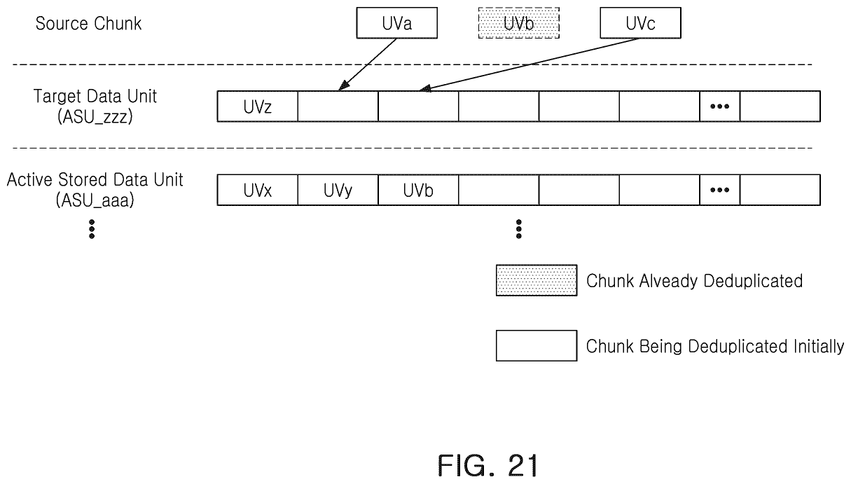

FIGS. 20 and 21 are diagrams illustrating a deduplication process according to example embodiments.

The process of storing the active storage data unit table illustrated in FIG. 20 and the source chunk illustrated in FIG. 21 in the target data unit may be similar to the examples described with reference to FIG. 18 and FIG. 19 above. In the description below, the differences from FIG. 18 and FIG. 19 may be described.

Referring to FIG. 20, the duplication data group may include the first to Nth active storage data unit. For the source bloom filter in the example embodiment illustrated in FIG. 11, the Hamming similarity of a bloom filter of each of the first to Nth active storage data unit ASU_aaa-ASU_zzz may be ‘0’ or ‘1.’

The calculated Hamming similarities 1 and 0 may not be higher than the threshold value 3. In some example embodiments in FIG. 20 and FIG. 21, the number of the plurality of active storage data units, N, may be the maximum allowable number N. As described with reference to operation S270 in FIG. 9, among the first to Nth active storage data units ASU_aaa-ASU_zzz, the Nth active storage data unit ASU_zzz having the smallest size may be selected as the target data unit.

The source chunk CHK2 corresponding to the unique value b UVb equally included in at least one of the source data unit and the first to Nth active storage data unit ASU_aaa-AUS_zzz may be classified as an already deduplicated chunk. The source data unit may be managed such that the source chunk CHK2 may reference to the position stored in the first active storage data unit ASU_aaa.

The source chunks CHK1 and CHK3 corresponding to the unique value a and the unique value c UVa and UVc equally included in the source data unit and the already deduplicated source data unit (not illustrated) may be classified as the first deduplicated chunk. The source chunks CHK1 and CHK3 may be stored in the target data unit ASU_ccc, and the source data unit may be managed such that the source chunks may reference to the positions stored in the target data unit ASU_ccc.

Referring to the active storage data unit table after the deduplication in some example embodiments illustrated in FIG. 20 is performed, unique values a and c UVa and UVc may be inserted into the source bloom filter of the Nth active storage data unit ASU_zzz, such that the source bloom filter may be updated. In this case, the fourth and first0 bits of the source bloom filter of the Nth active storage data unit ASU_zzz may be configured from the initial state (0) to the configured state (1). Also, the present size of the Nth active storage data unit ASU_zzz may increase by 2S. In this case, 2S may be the sum of capacities of the source chunks CHK1 and CHK3 stored in the Nth active storage data unit ASU_zzz.

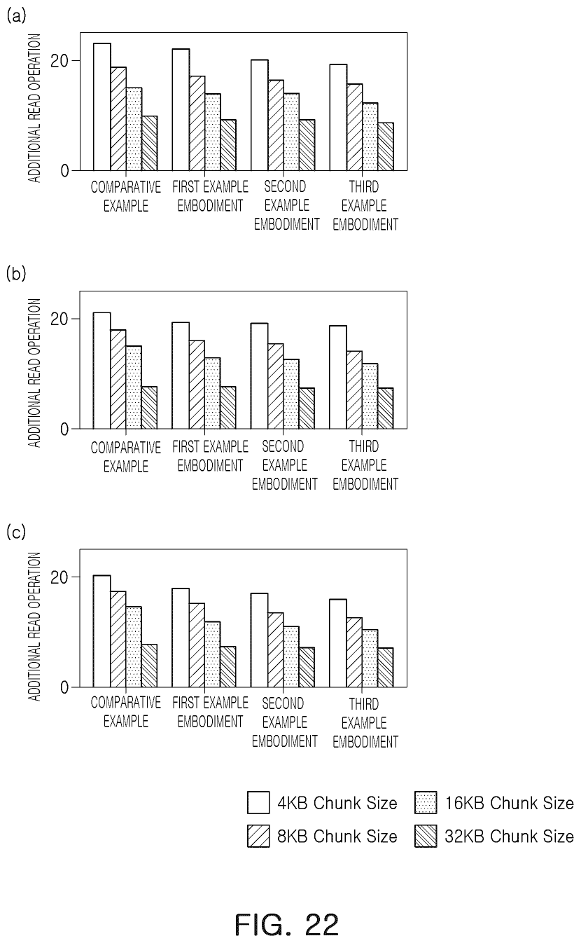

FIG. 22 is a diagram illustrating an effect of deduplication according to some example embodiments.

FIG. 22 may illustrate an additional read operation for the comparative example and the first to third example embodiments. The additional read operation may be an average value of the additional number of times the read operation is performed on the source chunks, required to output the deduplicated source data unit. As the fragmentation of the source data unit becomes more severe, the source chunks may be physically distributed and stored, such that the number of times the read operation for outputting the source data unit is performed may increase.

In the deduplication in the first to third example embodiments, at least one first deduplicated chunk included in the source data unit may be stored in the active storage data unit based on relevance. The active storage data unit in which the first deduplicated chunk is stored may be different for each source data unit.

In the first to third example embodiments, maximum allowable numbers of the active storage data units may be different. In the first example embodiment, up to 10 active storage data units may be allowed. In the second example embodiment, up to 100 active storage data units may be allowed. In the third example embodiment, up to 1000 active storage data units may be allowed.

In the deduplication in the comparative example and the other example embodiment, the first deduplicated chunks may be stored in sequence in a storage data unit. When the storage capacity of a storage data unit is exceeded, a new storage data unit may be generated. Thereafter, the first deduplicated chunks may be stored in sequence in the new storage data unit. Differently from the example embodiment, the position at which the first deduplicated chunks are stored may not be determined based on relevance.

In (a) in FIG. 22, the storage capacity of the storage data unit in the comparative example and the active storage data unit in the first to third example embodiment may be 4 MB. In (b) in FIG. 22, the storage capacity of the storage data unit in the comparative example and the active storage data unit in the first to third example embodiments may be 16 MB. In (c) in FIG. 22, the storage capacity of the storage data unit in the comparative example and the active storage data unit in the first to third example embodiments may be 64 MB.

Referring to (a) to (c) in FIG. 22, the additional read operation in the first to third example embodiments may be reduced as compared to the additional read operation in the comparative example. By performing deduplication in the first to third example embodiments, spatial locality of each chunk may be improved, and fragmentation may be alleviated.

Referring to (a) to (c) in FIG. 22, the larger the storage capacity of the storage data unit in the comparative example and the active storage data unit in the first to third example embodiments, the smaller the additional read operation may be. As the storage capacity of the active storage data unit in the first to third example embodiments increases, the size of the bloom filter may also increase. As the size of the bloom filter increases such that accuracy of Hamming similarity determination improves, the additional read operations may be further reduced.

Referring to the comparative example and the first to third example embodiments in (a) to (c) in FIG. 22, respectively, as the size of the chunk is smaller, additional read operations may increase. As the size of the chunk is smaller, the source data unit may be divided into more chunks. Accordingly, the deduplication rate of the chunk may increase, and spatial locality of each chunk may deteriorate.

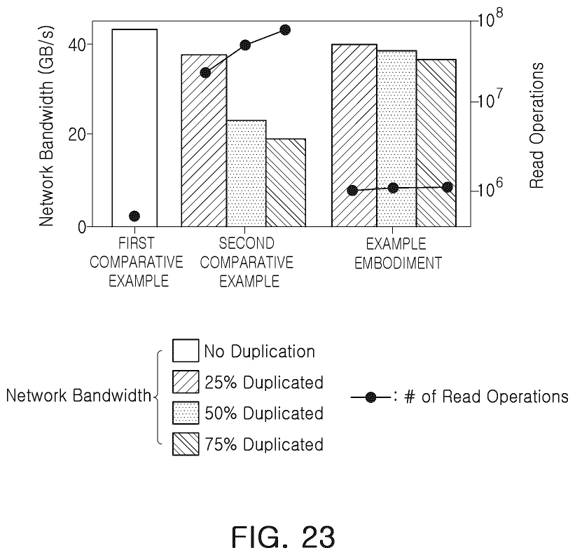

FIG. 23 is a diagram illustrating an effect of deduplication according to example embodiments.

FIG. 23 may illustrate read performance for a first comparative example, a second comparative example, and some example embodiments. The read performance may include a read operation and a network bandwidth.

In the deduplication in some example embodiments, at least one first deduplicated chunk included in a source data unit may be stored in an active storage data unit based on relevance. The active storage data unit in which the first deduplicated chunk is stored may be different for each source data unit. As the deduplication in the first to third example embodiment is performed, spatial locality of each chunk may be improved, and fragmentation may be alleviated.

In the first comparative example, different from the example embodiment, deduplication may not be performed. A plurality of the same chunks may be stored in a storage device, and fragmentation of the chunks may not occur. However, the efficiency of the use of the storage capacity of the storage system may be reduced.

In the deduplication in the second comparative example, different from the example embodiment, the first deduplicated chunks may be stored individually. In other words, the first deduplicated chunks may not be stored in order in the data unit, and may be stored chunk by chunk in a predetermined space. Accordingly, spatial locality of each chunk may be degraded, such that fragmentation may be aggravated.

In each in the second comparative example and the example embodiment in FIG. 23, the read operation and the network bandwidth may be included for the deduplication ratio, and the deduplication ratio may be 25%, 50%, and 75%. As the deduplication ratio increases, the read operation may increase, and the network bandwidth may decrease.

The read operation in the second comparative example and the example embodiment may further increase as compared to the read operation in the first comparative example. In other words, the read performance in the second comparative example and the example embodiment may further decrease as compared to the read performance in the first comparative example. Accordingly, the network bandwidth in the second comparative example and some example embodiments may be further reduced as compared to the network bandwidth in the first comparative example.

The average value of the read operation for the entirety of deduplication ratios may be lower in some example embodiments than in the second comparative example. Based on the read operation in the first comparative example, the increase in the read operation in some example embodiments may be smaller than the increase in the read operation in the second comparative example.

That is, the read performance in some example embodiments may be more excellent than the read performance in the second comparative example. In the example embodiment, by performing deduplication based on relevance, spatial locality of each chunk may improve, such that fragmentation may be alleviated. Accordingly, the read performance in some example embodiments may be improved.

The average value of the network bandwidth for the entirety of deduplication ratios may be higher in the example embodiment than in the second comparative example. Based on the network bandwidth in the first comparative example, the decrease in the network bandwidth in some example embodiments may be smaller than the decrease in the network bandwidth in the second comparative example.

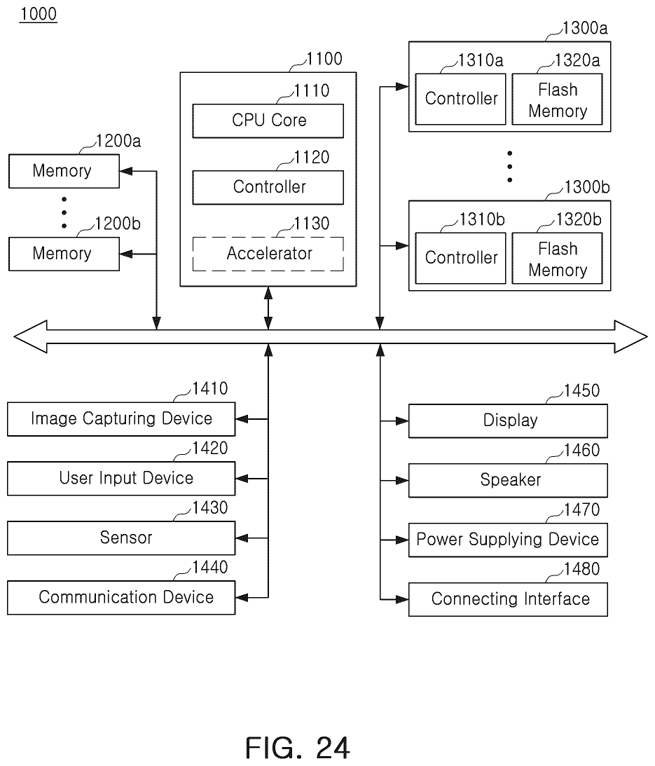

FIG. 24 is a diagram illustrating a system to which a storage device is applied according to some example embodiments.

The system 1000 in FIG. 24 may be implemented as or be included in a mobile system, such as one or more of a mobile phone, a smart phone, a tablet personal computer, a wearable device, a healthcare device, or an Internet of Things (IoT) device. However, the system 1000 in FIG. 24 is not necessarily limited to a mobile system, and may also be implemented as or be included in one or more of a personal computer, a laptop computer, a server, a media player, or an automotive device, such as a navigation device.

Referring to FIG. 24, the system 1000 may include a main processor 1100, memories 1200a and 1200b and storage devices 1300a and 1300b, and may further include one or more of an image capturing device 1410, a user input device 1420, a sensor 1430, a communication device 1440, a display 1450, a speaker 1460, a power supplying device 1470 and a connection interface 1480.

The main processor 1100 may control overall operations of the system 1000, more specifically, may control operations of other components included in the system 1000. The main processor 1100 may be implemented as a general-purpose processor, a dedicated processor, or an application processor.

The main processor 1100 may include one or more CPU cores 1110, and may further include a controller 1120 for controlling the memories 1200a and 1200b and/or the storage devices 1300a and 1300b. According to an embodiment, the main processor 1100 may further include an accelerator 1130, which may be a dedicated circuit for high-speed data operations such as artificial intelligence (AI) data operations. The accelerator 1130 may include a graphics processing unit (GPU), a neural processing unit (NPU), and/or a data processing unit (DPU), and may be implemented as a chip physically independent from other components of the main processor 1100.

The memories 1200a and 1200b may be used as main memory device of system 1000, and may include volatile memory such as a SRAM and/or DRAM, but may also include nonvolatile memory such as a flash memory, PRAM and/or RRAM. The memories 1200a and 1200b may also be implemented in the same package as the main processor 1100.

The storage devices 1300a and 1300b may function as a nonvolatile storage device for storing data regardless of whether power is supplied, and may have a relatively large storage capacity as compared to the memories 1200a and 1200b. The storage devices 1300a and 1300b may include controllers 1310a and 1310b and nonvolatile memories (NVM) 1320a and 1320b for storing data under control of the controllers 1310a and 1310b.

The storage devices 1300a and 1300b may be included in the system 1000 in a state of being physically separated from the main processor 1100, or may be implemented in the same package as the main processor 1100. Also, the storage devices 1300a and 1300b may have a form such as an SSD (solid state device) or a memory card, and may be detachably coupled to other components of the system 1000 through an interface such as the connection interface 1480 described later. A standard specification such as one or more of universal flash storage (UFS), embedded multi-media card (eMMC), or non-volatile memory express (NVMe) may be applied to the storage devices 1300a and 1300b, but some example embodiments thereof is not limited thereto.

According to some example embodiments, in the storage devices 1300a and 1300b, at least one first deduplicated chunk included in a source data unit may be stored at a position selected based on relevance. In other words, at least one first deduplicated chunk may be stored at consecutive memory addresses of the storage data unit. Accordingly, spatial locality of each chunk may be improved, such that fragmentation may be alleviated. Also, read performance of the storage devices 1300a and 1300b may be improved.

The imaging device 1410 may capture still images or moving images, and may be implemented as a camera, a camcorder, and/or a webcam.

The user input device 1420 may receive various types of data input from a user of the system 1000, and may be implemented as or be included in one or more of a touch pad, a keyboard, a mouse, and/or a microphone.

The sensor 1430 may sense various types of physical quantities obtained from an external entity of the system 1000, and may convert the sensed physical quantities into electrical signals. The sensors 1430 may be temperature sensors, pressure sensors, light sensors, position sensors, acceleration sensors, biosensors, and/or gyroscope sensors.

The communication device 1440 may perform signal transmission and reception between other devices externally of the system 1000 in accordance with various communication protocols. The communication device 1440 may be implemented to include an antenna, a transceiver, and/or a modem.

The display 1450 and the speaker 1460 may function as output devices for outputting visual information and auditory information to a user of the system 1000, respectively.

The power supplying device 1470 may appropriately convert power supplied from a battery (not illustrated) embedded in the system 1000 and/or an external power source and supply the power to each of the components of the system 1000.

The connection interface 1480 may provide a connection between the system 1000 and an external device connected to the system 1000 and exchanging data with the system 1000. The connection interface 1480 may be implemented by various interface methods such as one or more of advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, universal serial bus (USB), secure digital (SD) card, multi-media card (MMC), eMMC, UFS, embedded universal flash storage (eUFS), compact flash (CF) card interface, or the like.

According to the aforementioned example embodiments, at least one chunk which may be first deduplicated in a source data unit received from a host may be stored in a target data unit, which is one of a plurality of active storage data units. In this case, for the source data unit, the similarity with the plurality of active storage data units may be calculated using a bloom filter and the Hamming similarity, and the target data unit may be selected from among the plurality of active storage data units based on the similarity. Accordingly, fragmentation of source chunks may be alleviated or improved up, and the number of times the source chunks are read for outputting the deduplicated source data unit may be reduced or minimized.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While some example embodiments have been illustrated and described above, it will be configured as apparent to those of ordinary skill in the art that modifications and variations could be made without departing from the scope of the present disclosure as defined by the appended claims. Additionally, example embodiments are not necessarily mutually exclusive with one another. For example, some example embodiments may include one or more features described with reference to one or more figures, and may also include one or more other features described with reference to one or more other figures.

What is claimed is:

1. A control method of a storage system, the control method comprising:
dividing a source data unit into a plurality of source chunks, the source data among a plurality of source data units received from a host, the source data a target of deduplication;
generating a unique value for each of the plurality of source chunks;
inserting the unique values into a source bloom filter of the source data unit and updating the source bloom filter;
calculating a Hamming similarity with a storage bloom filter of each of a plurality of active storage data units for the source bloom filter;
selecting an active storage data unit based on a highest Hamming similarity among the plurality of active storage data units as a target data unit;
classifying each of the plurality of source chunks as one of a first deduplicated chunk, an already deduplicated chunk, or a unique chunk using the unique values; and
storing at least one of the first deduplicated chunks in the target data unit.

2. The control method of claim 1, further comprising:
inserting the first deduplicated chunk into a target bloom filter of the target data unit and updating a bit of the target bloom filter.

3. The control method of claim 1, wherein each of the unique values has a fixed size, and each of the unique values is generated by a hash function.

4. The control method of claim 1, wherein a size of the source bloom filter and a size of the storage bloom filter are the same.

5. The control method of claim 4, wherein a size of the source bloom filter and a size of the storage bloom filter are greater than a number of chunks allowed for each of the plurality of active storage data units.

6. The control method of claim 1, wherein allowable sizes of the plurality of active storage data units are the same.

7. The control method of claim 6, further comprising:
changing the target data unit to a storage data unit and excluding the changed unit from the plurality of active storage data units when the first deduplicated chunk is added to the target data unit and a size of the target data unit becomes greater than an allowable size.

8. The control method of claim 7, wherein the classifying each of the plurality of source chunks includes:
classifying a source chunk corresponding to a same unique value as the first deduplicated chunk in response to the source data unit including a unique value the same as an already deduplicated source data unit among the plurality of source data units;
classifying a source chunk corresponding to a same unique value as the already deduplicated chunk in response to the source data unit including a unique value the same as the plurality of active storage data units or the storage data unit; and
classifying chunks other than the first deduplicated chunk and the already deduplicated chunk among the plurality of source chunks as the unique chunk.

9. The control method of claim 8, further comprising:
accessing the first deduplicated chunk and the already deduplicated chunk by referencing a position of a stored chunk corresponding to the same unique value.

10. The control method of claim 1, wherein the Hamming similarity indicates a number of positions in which each of bits in the same position has a value of logical ‘1’ in the source bloom filter and the storage bloom filter.

11. The control method of claim 10, wherein the higher the Hamming similarity, the greater the number of chunks having the same unique value in the source data unit and the active storage data unit.

12. A control method of a storage system, the control method comprising:
dividing a source data unit into a plurality of source chunks, the source unit a target of deduplication, the source unit among a plurality of source data units received from a host;
generating a unique value for each of the plurality of source chunks;
inserting the unique values into a source bloom filter of the source data unit and updating the source bloom filter;
calculating a Hamming similarity with a storage bloom filter of each of a plurality of active storage data units in which a deduplicated chunk is stored for the source bloom filter;
selecting a target data unit among the plurality of active storage data units using the Hamming similarities; and
adding at least one first deduplicated chunk among the plurality of source chunks to the target data unit.

13. The control method of claim 12, wherein the selecting the target data unit includes selecting an active storage data unit based on the highest Hamming similarity among the plurality of active storage data units as the target data unit in response to one Hamming similarity among the Hamming similarities is the highest.

14. The control method of claim 12, wherein the selecting the target data unit includes selecting the target data unit using a number of the plurality of active storage data units in response to the plurality of Hamming similarities being the highest among the Hamming similarities or in response to the Hamming similarities being lower than a threshold value.

15. The control method of claim 14, wherein the selecting the target data unit includes selecting an active storage data unit based on the smallest size among the plurality of active storage data units as the target data unit in response to the number of the plurality of active storage data units is a maximum allowable number.

16. The control method of claim 14, wherein the selecting the target data unit includes generating a new active storage data unit and selecting the new active storage data unit as the target data unit in response to the number of the plurality of active storage data units is equal to or less than a maximum allowable number.

17. The control method of claim 14, wherein the threshold value is varied depending on the number of the plurality of active storage data units.

18. The control method of claim 14, wherein the threshold value is varied depending on distribution of the Hamming similarities.

19. A control method of a storage system, the control method comprising:
dividing a source data unit, the source data unit being a target of deduplication, into a plurality of source chunks, and generating a unique value of each of the plurality of source chunks;
inserting the unique values into a source bloom filter of the source data unit and updating the source bloom filter;
calculating a Hamming similarity with a storage bloom filter of each of a plurality of active storage data units in which the deduplicated chunks are stored for the source bloom filter;
selecting a target data unit from among the plurality of active storage data units using the Hamming similarities;
classifying each of the plurality of source chunks as one of a first deduplicated chunk, an already deduplicated chunk, or a unique chunk using the unique values;
adding the first deduplicated chunk to the target data unit and referencing a position of the target data unit to access the first deduplicated chunk; and
inserting the first deduplicated chunk into a target bloom filter of the target data unit and updating a bit of the target bloom filter.

20. The control method of claim 19, wherein the selecting the target data unit includes:
selecting an active storage data unit based on the highest Hamming similarity calculated among the plurality of active storage data units as the target data unit in response to one Hamming similarity among the Hamming similarities being the highest;
selecting an active storage data unit based on the smallest size among the plurality of active storage data units as the target data unit in response to a plurality of Hamming similarities among the Hamming similarities are being highest and the number of the plurality of active storage data units being a maximum allowable number; and
generating a new storage data unit and selecting the new storage data unit as the target data unit in response to a plurality of Hamming similarities among the Hamming similarities being the highest and the number of the plurality of active storage data units being equal to or less than a maximum allowable number.
